(19) United States
(12) Patent Application Publication
(10) Pub. No.: US 2011/0182412 A1
(43) Pub. Date: Jul. 28, 2011

(54) COMMUNICATION DEVICE

(76) Inventors: Shinji Takuno, Tottori (JP); Masahito Mizune, Tottori (JP); Satoru Moriyama, Tottori (JP)

(21) Appl. No.: 12/678,619

(22) PCT Filed: May 20, 2008
(86) PCT No.: PCT/JP2008/059175

§ 371 Date: Mar. 17, 2010

(30) Foreign Application Priority Data
Sep. 21, 2007 (JP) 2007-245574
Sep. 27, 2007 (JP) 2007-251501
Dec. 26, 2007 (JP) 2007-334625
Dec. 26, 2007 (JP) 2007-334626

(51) Int. Cl. H04M 11/04; H04W 4/22

(52) U.S. Cl. 379/39; 455/404.1

(57) ABSTRACT

A communication device is provided in which, in case of a power failure caused by an earthquake, a slave unit can be used as an illumination device, which includes a high-visibility display portion, in which notification lamps to be lit or blinked can be selected by a user, and in which the color of an incoming lamp that is lit at the time of normal reception can be prevented from being similar to that at the time of reception of the earthquake early warning. When a predicted period up to the arrival of a primary shock is calculated, the lighting and extinguishing of backlights arranged behind a group of operation buttons is controlled, and any of digits from 0 to 9 is displayed on an input portion. The colors of the lit backlights are changed according to the value of a predicted seismic intensity, and the predicted period is displayed. The color of the incoming lamp lit when the earthquake early warning is received cannot be set at the color of the incoming lamp lit when normal reception is performed. The user can select the incoming lamps to be lit or blinked.

### TECHNICAL FIELD

The present invention relates to a communication device that is connected to a telephone line provided by a carrier such as NTT, and more particularly to a communication device that can provide evacuation instructions and notification of a predicted period up to the arrival of a primary shock when detecting an earthquake early warning distributed by the Japan Meteorological Agency and that can be used as an illumination device.

### BACKGROUND ART

In recent years, as communication infrastructure has advanced, a variety of additional services related to the communication have been widely available. In particular, among telephone devices, telephone devices are widely used that can be connected not only to common telephone lines but also to wide area communication networks such as IP telephone networks and the Internet and that can thus receive various services.

As one of the functions included in this type of telephone device, there is a function for receiving the earthquake early warning distributed by the Japan Meteorological Agency in case of an earthquake; telephone devices having this function are available. The earthquake early warning is an information distribution service, for example, that will be started on Oct. 1, 2007 in Japan. Users who purchase telephone devices for the earthquake early warning and who contract with earthquake early warning distribution companies can utilize this service.

The contractor connects the telephone device to a wide area communication network such as the Internet and can thereby receive, in case of an earthquake, various types of information on the earthquake through the communication network. When the telephone device receives an earthquake occurrence notification, it uses area information and the like previously stored in the telephone device to calculate a predicted seismic intensity in the area where the telephone device is located, a predicted time when a primary shock (=part of earthquake shocks that is sensed most strongly by the human body, normally, S waves) reaches the area and the like.

The user is notified of the calculation results by, for example, the screen display of a liquid crystal panel or the sound output of a speaker. Thus, the user can perform evacuation activities such as huddling under a table and extinguishing a fire source.

In patent document 1, as a device which can receive the earthquake early warning as described above, there is disclosed an image processing device that can reduce, as compared with a conventional device, the possibility that a secondary disaster such as a fire caused by the earthquake occurs. In patent document 2, there is disclosed an earthquake prediction information delivery system that can provide notification of the occurrence of an earthquake as character information to an information terminal device, such as a mobile telephone and a personal computer, of a contractor of the earthquake early warning.

In patent document 3, there is disclosed a communication terminal that calculates, when receiving the earthquake early warning, the current location, an allowance period since the reception of the earthquake early warning until the arrival of the primary shock and the completion time of the primary shock, and that can display the calculation results. In patent document 4, there is disclosed a technology with which the color of an incoming lamp is set by the operation of a numeric keypad.
Patent document 1: JP-A-2007-72917
Patent document 2: JP-A-2006-260497
Patent document 3: JP-A-2007-47936
Patent document 4: JP-A-2001-111656

### DISCLOSURE OF THE INVENTION

### Problems to be Solved by the Invention

However, in the technologies disclosed in patent documents 1 to 4, the function of assisting the evacuation activity of the user when a power failure caused by an earthquake occurs is not included. Moreover, when the user is in a location somewhat away from a terminal device or an information processing device, it is difficult to visually identify information indicating the earthquake early warning.

With the technologies disclosed in patent documents 3 and 4, it is possible to include a plurality of lamps and provide notification by the lighting or blinking of not only a display portion but also the lamps. However, depending on the situation in which the communication device is placed, it may be difficult to visually identify the lamps. If the color of the incoming lamp that is lit at the time of normal reception is set similar to that at the time of reception of the earthquake early warning, it is impossible for the user to instantaneously determine whether the normal reception is performed or the earthquake early warning is received.

The present invention is designed to overcome these problems. An object of the present invention is to provide a communication device which includes a master unit connected to a communication network and a slave unit capable of wirelessly communicating with the master unit, in which, in case of a power failure caused by an earthquake, the slave unit can be used as an illumination device, which includes a high-visibility display portion, in which notification lamps to be lit or blinked among a plurality of notification lamps can be selected by a user, and in which the color of an incoming lamp that is lit at the time of normal reception can be prevented from being similar to that at the time of reception of the earthquake early warning.

### Means for Solving the Problem

To achieve the above object, according to one aspect of the present invention, there is provided a communication device that includes: a first communication portion connectable to a communication network; an earthquake information calculation portion that receives, with the first communication portion, earthquake early warning through the communication network and that calculates a predicted period up to an arrival of a primary shock and a predicted seismic intensity; an input portion including a group of operation buttons; and a light emission portion including light emission members arranged behind the group of operation buttons, the communication device further including: a predicted period display portion that controls the light emission portion such that the light emission members are lit/extinguished according to a value of the predicted period.

With this configuration, the communication device of the present invention is provided with the first communication portion that includes a network card or a wireless LAN device connectable to the communication network. The communication device is also provided with the earthquake information calculation portion that receives, with the first communication portion, the earthquake early warning distributed by the Japan Meteorological Agency through a wide area communication network such as the Internet, and that calculates the predicted seismic intensity and the predicted period up to the arrival of the primary shock in an area where the communication device is located.

The communication device is further provided with the input portion including the group of operation buttons and the light emission portion including the light emission members, such as LEDs, arranged behind the group of operation buttons. The communication device is yet further provided with a backlight control portion (=predicted period display portion) that controls the lighting and extinguishing of backlights which are the light emission members arranged behind or within the group of operation buttons and which are used to display the predicted period up to the arrival of the primary shock on the input portion. In this way, with the group of operation buttons, it is possible to displays the predicted period by the same method as used in an electronic display panel.

The communication device of the present invention may be provided with a storage portion that stores light emission member information indicating which light emission members need to be lit/extinguished to display any of digits from 0 to 9 with the light emission portion, and, in the communication device, the predicted period display portion may determine, with the light emission member information, which light emission members are lit/extinguished according to the predicted period, and control the light emission portion.

With this configuration, the communication device of the present invention is provided with the storage portion such as memory. The storage portion stores the information (=light emission member information) that indicates, on a digit-by-digit basis, which backlights of operation buttons need to be lit/extinguished to display any of digits from 0 to 9 with the light emission portion. When the backlight control portion displays each digit, it reads and references the light emission member information from the storage portion to determine which types of backlights are lit/extinguished according to the displayed digit.

The communication device of the present invention may include: a main communication device including: the first communication portion; the earthquake information calculation portion; the input portion; the light emission portion; the predicted period display portion; and an earthquake information transmission portion that transmits, with the first communication portion, earthquake information including the predicted period up to the arrival of the primary shock and the predicted seismic intensity calculated by the earthquake information calculation portion; and a sub-communication device including: a second communication portion that can communicate with the main communication device; an earthquake information acquisition portion that acquires the earthquake information from information received with the second communication portion; the input portion; the light emission portion; and the predicted period display portion.

With this configuration, the communication device of the present invention is configured to include the master unit (=main communication device) and the slave unit (=sub-communication device). The master unit is provided with the first communication portion, the earthquake information calculation portion, the input portion, the light emission portion and the backlight control portion. The master unit is further provided with the earthquake information transmission portion that transmits, to the slave unit, earthquake information calculated by the earthquake information calculation portion.

The slave unit is provided with the second communication portion that can communicate with the master unit and the earthquake information acquisition portion that extracts, from various types of information received by the second communication portion, the earthquake information transmitted from the second communication portion. The slave unit is further provided with the input portion, the light emission portion and the backlight control portion. Thus, it is possible to display the predicted period with the group of operation buttons both in the master unit and in the slave unit.

In the communication device of the present invention, the first communication portion may include a wireless communication portion connectable to a wireless communication network, the earthquake information transmission portion may transmit, with the wireless communication portion included in the first communication portion, the earthquake information to the sub-communication device, the second communication portion may include a wireless communication portion connectable to the wireless communication network and the earthquake information acquisition portion may acquire the earthquake information from information received with the wireless communication portion included in the second communication portion.

With this configuration, in the communication device of the present invention, the master unit and the slave unit are provided with the wireless communication portion including an antenna device and connectable to the wireless communication network. The earthquake information transmission portion of the master unit transmits, with the wireless communication portion, the calculated earthquake information to the slave unit. The earthquake information acquisition portion of the slave unit receives, with the wireless communication portion, the earthquake information transmitted from the master unit. Thus, since it is unnecessary to connect the master unit and the slave unit together with a wired communication network, even when the user travels while carrying the slave unit, it is possible to receive the notification of the predicted period.

In the communication device of the present invention, the predicted period display portion may update the predicted period as time passes, and control the light emission portion such that, each time the predicted period is updated, a figure indicating an updated predicted period is displayed with the light emission members.

With this configuration, the backlight control portion temporarily stores the received predicted period in the memory, and updates the predicted period every predetermined period, for example, every second. Each time the predicted period is updated, the light emission portion is controlled such that the value of the updated predicted period is displayed by the backlights arranged behind the group of operation buttons. Hence, the master unit transmits the predicted period to the slave unit only once, and thus it is possible for the slave unit to update the predicted period as time passes and perform its countdown display.

In the communication device of the present invention, the earthquake information transmission portion may update the predicted period as time passes, and transmit, with the first communication portion, an updated predicted period to the sub-communication device each time the predicted period is updated.

With this configuration, the earthquake information transmission portion of the master unit updates the predicted period every predetermined period, for example, every second. Each time the predicted period is updated, the earthquake information transmission portion transmits, with the first communication portion, the value of the updated predicted period to the slave unit. Thus, even if the slave unit has at least the function of displaying the received predicted period, it is possible to perform the countdown display of the predicted period.

In the communication device of the present invention, the predicted period display portion may control the light emission portion such that colors of the lit light emission members are changed according to a value of the predicted seismic intensity included in the earthquake information.

With this configuration, the backlight control portion changes, according to the value of the calculated predicted seismic intensity, the colors of the backlights lit when the predicted period is displayed, and displays the predicted period. Thus, it is possible to provide a notification of an approximate seismic intensity together with the predicted period; for example, white light is generally emitted, but, if the predicted seismic intensity is more than seismic intensity 5, red light is emitted.

According to another aspect of the present invention, there is provided a communication device including: a reception detection portion that detects reception; a light emission portion that emits light according to the detection of the reception by the reception detection portion; a setting portion that sets a color of light emitted by the light emission portion; and a prevention portion that prevents, when the setting portion sets the color of light emitted, a predetermined color from being registered as the color of light emitted by the light emission portion.

In the communication device of the present invention, when the setting portion sets the color of light emitted, the prevention portion may prevent red from being registered as the color of light emitted by the light emission portion.

The communication device of the present invention may further include a receiving portion that receives the earthquake early warning; and light emission portions that light up or blink based on the reception by the receiving portion, and in the communication device, two or more light emission portions may be included, and the light emission portions that are lit or blinked when the receiving portion receives the earthquake early warning may be selectable.

In the communication device of the present invention, the communication device may be shaped substantially in the form of a rectangular parallelepiped, the light emission portions that light up or blink may be arranged in four corners of the rectangular parallelepiped and, among the light emission portions, light emission portions that are lit or blinked may be selectable.

In the communication device of the present invention, the communication device may be shaped substantially in the form of a rectangular parallelepiped, and may include a receiving portion that receives the earthquake early warning and light emission portions that light up or blink based on the reception by the receiving portion, the light emission portions that light up or blink may be arranged in four corners of the rectangular parallelepiped and, among the light emission portions, light emission portions that are lit or blinked may be selectable.

### Advantages of the Invention

With this configuration, when the predicted period up to the arrival of the primary shock is calculated, the backlight control portion controls the lighting and extinguishing of the backlights arranged behind the group of operation buttons. Thus, it is possible to display the predicted period with the group of operation buttons by the same method as used in an electronic display panel. This makes it possible to display the predicted period with the display of a size larger than that of a liquid crystal panel included in a communication device, with the result that the visibility is enhanced. Hence, even when the user is in a location somewhat away from the communication device, it is possible to confirm the predicted period, with the result that the convenience of the user is enhanced.

With this configuration, the light emission member information is previously stored that indicates, on a digit-by-digit basis, which backlights of operation buttons need to be lit/extinguished to display, with the light emission portion, any of digits from 0 to 9 on the input portion. Thus, by referencing the light emission member information, it is possible to easily and accurately perform the backlight control for displaying each digit.

With the configuration of the present invention, it is possible to display the predicted period up to the arrival of the primary shock with the group of operation buttons both in the master unit and in the slave unit. Hence, even when the user is not close to the master device, it is possible to confirm the predicted period with the slave unit, with the result that the convenience of the user is enhanced.

With the configuration of the present invention, the master unit and the slave unit are provided with the wireless communication portion, and exchange the predicted period through the wireless communication network. Hence, even when the user travels while carrying the slave unit, it is possible to receive the notification of the predicted period. Therefore, for example, the user can confirm the predicted period while performing an evacuation activity of huddling under a table to cope with the arrival of the primary shock, with the result that the convenience of the user is enhanced.

With the configuration of the present invention, the backlight control portion updates the predicted period every predetermined period, and displays the updated predicted period. Hence, for example, the master unit transmits the predicted period to the slave unit only once, and thus it is possible for the slave unit to update the predicted period as time passes and perform the countdown display. Therefore, when the present invention is practiced, it is possible to practice it by only adding a function to the slave without newly adding a function to the master unit.

With the configuration of the present invention, the earthquake information transmission portion of the master unit updates the predicted period every predetermined period, and transmits the predicted period to the slave unit each time the updating is performed. Thus, it is possible to avoid the situation where the predicted periods displayed by a plurality of slave units differ from each other, and where the user is confused when they determine which predicted period is proper. Since the number of functions that slave units have can be reduced, for example, when the number of slaves is extremely large, it is possible to achieve cost reduction and easily perform the maintenance.

With the configuration of the present invention, the colors of the lit backlights are changed according to the value of the predicted seismic intensity, and the predicted period is displayed. Since an approximate predicted seismic intensity can be shown in this way, it is possible to increase the amount of information notified to the user, with the result that the convenience of the user is enhanced.

With the configuration of the present invention, the color of an incoming lamp lit (or blinked) when the earthquake early warning is received cannot be set at the color of the incoming lamp lit (or blinked) when normal reception is performed (for example, when a call is received). Thus, it is possible to avoid a problem where the color of the incoming lamp lit when the earthquake early warning is received is erroneously set at the same color as that of the incoming lamp lit when normal reception is performed, and where it is impossible to instantaneously determine which one of the reception of the earthquake early warning and the normal reception is performed at the time of reception.

With the configuration of the present invention, since the user can select the incoming lamps to be lit or blinked, it is possible to select the lamps necessary to be lit or blinked according to the arrangement of the communication device.

### BRIEF DESCRIPTION OF DRAWINGS

FIG. 1 A block diagram showing the configuration of a telephone system of the present invention;

FIG. 2 A block diagram showing the configuration of a master unit in a communication device according to a first embodiment of the invention;

FIG. 3 A block diagram showing the configuration of a slave unit in the communication device according to the first embodiment of the invention;

FIG. 4 A flowchart showing predicted period notification processing performed in the master unit according to the first embodiment of the invention;

FIG. 5 A flowchart showing predicted period notification processing performed in the slave unit according to the first embodiment of the invention;

FIG. 6 A diagram showing the appearance of the slave unit in the communication device of the invention;

FIG. 7 A schematic diagram showing an input portion of the slave in the communication device of the invention;

FIG. 8 A flowchart showing predicted period notification processing performed in a master unit according to a second embodiment of the invention;

FIG. 9 A flowchart showing predicted period notification processing performed in a slave unit according to the second embodiment of the invention;

FIG. 10 A block diagram showing the configuration of a master unit according to a third embodiment of the invention;

FIG. 11 A block diagram showing the configuration of a slave unit according to the third embodiment of the invention;

FIG. 12 A diagram showing the appearance of a communication device according to the third embodiment of the invention;

FIG. 13 A flowchart showing the operation of the master unit according to the third embodiment of the invention;

FIG. 14 A flowchart showing the operation of a master unit according to a fourth embodiment of the invention;

FIG. 15 A flowchart showing the operation of a slave unit according to the fourth embodiment of the invention;

FIG. 16 A block diagram showing the configuration of a slave unit according to a fifth embodiment of the invention;

FIG. 17 A diagram showing the appearance of the slave unit according to the fifth embodiment of the invention;

FIG. 18 A perspective view showing the configuration of an illumination portion included in the slave unit according to the fifth embodiment of the invention;

FIG. 19 A flowchart showing processing performed, when the earthquake early warning is received, on a maser unit according to the fifth embodiment of the invention; and

FIG. 20 A flowchart showing processing performed, when the earthquake early warning is received, on the slave unit according to the fifth embodiment of the invention.

### LIST OF REFERENCE SYMBOLS

1 Master unit (main communication device)
11a Earthquake information calculation portion
11b Earthquake information transmission portion
11c Backlight control portion (predicted period display portion)
11d Early warning receiving portion
11e Earthquake detection transmission portion
11f Evacuation instruction portion
11g Evacuation instruction registration portion
12 Memory (storage portion)
13 Display portion
14 Input portion
15 Communication control portion (first communication portion)
16 Antenna device (wireless communication portion)
18 Speaker
20 Light emission portion
2 Slave unit (sub-communication device)
21a Earthquake information acquisition portion
21b Backlight control portion (predicted period display portion)
21c Earthquake detection receiving portion
21d Evacuation instruction portion
21e Evacuation instruction registration portion
21f Light emission amount adjustment portion
22 Memory (storage portion)
23 Display portion
24 Input portion
25 Communication control portion (second communication portion)
26 Antenna device (wireless communication portion)
28 Speaker
111 Incoming lamp (light emission portion)
112 Incoming lamp (light emission portion)
113 Incoming lamp (light emission portion)
114 Incoming lamp (light emission portion)

### BEST MODE FOR CARRYING OUT THE INVENTION

Embodiments of the present invention will be described below with reference to the accompanying drawings. The embodiments shown here are examples, and the invention is not limited to these embodiments.

### Embodiment 1

### <1-1. The Configuration of a Telephone System>

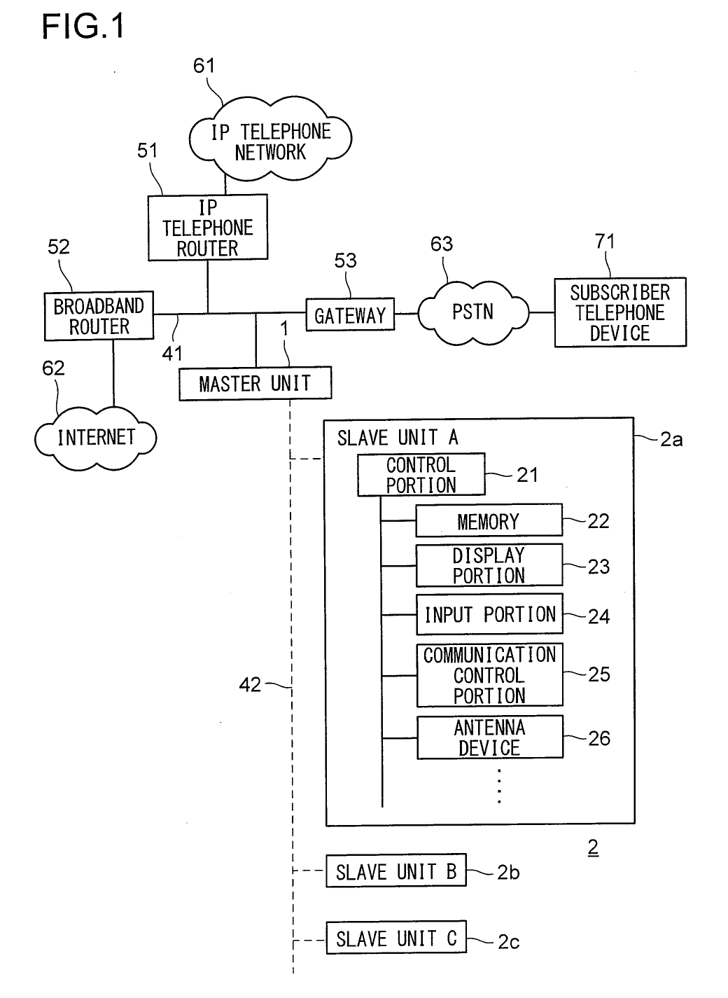

FIG. 1 is a block diagram showing the configuration of a telephone system including a cordless telephone device (=communication device) of the present invention. This system is configured to include at least a master unit 1 (=main communication device), slave units 2 (=sub-communication devices), a wired LAN 41, a wireless communication network 42, an IP telephone router 51, a broadband router 52, a gateway 53, an IP telephone network 61, the Internet 62, a PSTN 63 (=public switched telephone network) and a subscriber telephone device 71.

The cordless telephone device of the present invention is a cordless telephone device that can connect to an IP communication network, and corresponds to the master unit 1 and a plurality of slave units 2 (slave units A2a to C2c) shown in the figure. The master unit 1 is an IP telephone device which is connected to the wired LAN 41 such that sound communication can be achieved through the telephone network. The master unit 1 has the function of relaying communication between the wired LAN 41 and the wireless communication network 42. Thus, the slave units 2, which will be described later, can achieve communication through the master unit 1 via the IP telephone network 61 or the PSTN 63. The master unit 1 also has the function of receiving the earthquake early warning distributed by the Japan Meteorological Agency through the Internet 62. The internal structure of the master unit 1 will be described in detail later.

The slave units 2 are a wireless communication device that is connected to the wireless communication network 42, which will be described later, and that communicates with the master unit 1 and thereby allows sound communication with another telephone device through the IP telephone network 61 or the PSTN 63. The internal configuration of the slave units 2 will be described in detail later.

The wired LAN 41 is a local network to which the master unit 1, the IP telephone router 51, the broadband router 52, the gateway 53 and the like are connected by wiring. The above-mentioned devices are connected to the wired LAN 41 and can thereby communicate with each other. Examples of physical means that forms the wired LAN 41 include “10BASE-T (standardized as IEEE802.3i)” in which a twisted pair cable is used and “100BASE-TX (standardized as IEEE802.3u).”

The wireless communication network 42 is a small-scale communication network to which the master unit 1 and a plurality of slave units 2 are connected wirelessly. Specifically, for example, the intercommunication is achieved by the use of, for example, a communication method that complies with “FHSS-WDCT (frequency hopping spread spectrum—world digital cordless telephone)” utilizing 2.4 GHz (gigahertz) band radio.

The IP telephone router 51 and the broadband router 52 are network relay devices for connecting a plurality of IP networks with each other. Specifically, the transfer is performed by analyzing the protocol of part of the network layer (the third layer) and the transport layer (the fourth layer) in the OSI (open systems interconnection) reference model. In this embodiment, the IP telephone router 51 serves to connect two IP networks, namely, the wired LAN 41 and the IP telephone network 61. The broadband router 52 serves to connect two IP networks, namely, the wired LAN 41 and the Internet 62.

The gateway 53 is a protocol converter that connects networks of different protocol systems. The gateway 53, for example, connects the wired LAN 41 and the PSTN 63 and performs signal conversion with a signaling protocol such as SIP, and thereby allows communication between the networks.

The IP telephone network 61 is a communication network that utilizes a VoIP (voice over internet protocol) technology for part or the whole of the telephone network; a so-called broadband line such as FTTH (fiber to the home) or ADSL (asymmetric digital subscriber line) is used as a communication line. The VoIP is a technology with which sound is compressed by various coding methods and converted into packets, and those packets are transferred in real time through the IP network. Thus, the IP telephone network 61 can provide not only a voice communication service but also a picturephone service in which images are exchanged and the like.

The Internet 62 is a wide area communication network that is configured by interconnecting networks employing communication protocols. Large and small computer networks are coupled with each other to configure the international communication network. As the main standard communication protocol, TCP/IP is employed.

The PSTN 63 is a common subscriber telephone network. Telephone devices are connected to the terminals of the PSTN 63; the PSTN 63 is used to perform voice communication by connecting to a party to be called with a circuit switching method. The subscriber telephone device 71 is a telephone device with which a telephone subscriber uses the PSTN 63 to perform voice communication with other subscriber telephone devices and IP telephone devices.

### <1-2. The Internal Configuration of the Master Unit>

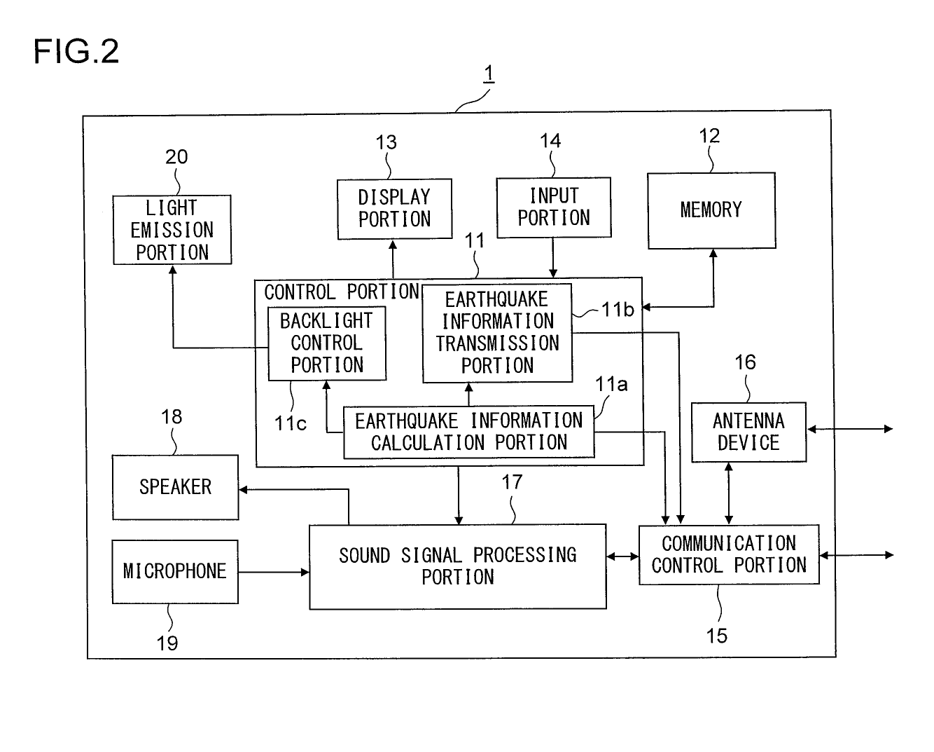

FIG. 2 is a block diagram showing the interior of the master unit 1 according to the first embodiment of the invention. The master unit 1 is configured to include at least a control portion 11, a memory 12 (=storage portion), a display portion 13, an input portion 14, a communication control portion 15 (=first communication portion), an antenna device 16 (=wireless communication portion), a sound signal processing portion 17, a speaker 18, a microphone 19 and a light emission portion 20.

The control portion 11 is a central processing unit for collectively controlling communication control processing (such as the exchange of sound data, making a call and the detection of whether a call is received) by controlling the individual portions of the master unit 1. As function portions that are provided by executing programs on the central processing unit included in the control portion 11, the control portion 11 is provided with an earthquake information calculation portion 11a, an earthquake information transmission portion 11b and a backlight control portion 11c (=predicted period display portion).

The earthquake information calculation portion 11a uses the communication control portion 15 to receive the earthquake early warning from the Internet 62. The earthquake early warning includes data such as an earthquake detection time, an earthquake identification number, an epicenter place-name code, the latitude and longitude of a hypocenter, the depth of the hypocenter, the magnitude, the maximum predicted seismic intensity and the accuracy of data (such as a system and a processing method used in the measurement). The predicted seismic intensity and the predicted period up to the arrival of a primary shock that are included in the earthquake early warning are approximate; it is necessary for a receiving device to calculate the detailed predicted seismic intensity and the like for each area.

The calculation processing is roughly divided into two types of processing, namely, single-station processing and multiple-station processing. The single-station processing is local one-point measurement processing, such as a P wave measurement or a level method, that is used in a case where an earthquake occurs near the station. The multiple-station processing is used to calculate, from the results of multiple pieces of single-station processing, the predicted seismic intensity in a specific location and the time when a primary shock reaches the location. Typical examples of the method of performing the processing include a territory method and a grid search method.

The earthquake information calculation portion 11a performs the multiple-station processing based on the results of multiple pieces of single-station processing included in the earthquake early warning and latitude/longitude information stored in the memory 12. Specifically, for example, earthquake's three elements (Epicenter: X, Y; Time: T; Magnitude: M) are first determined from the results of the multiple pieces of single-station processing. Then, a sensible radius R is determined from an epicentral distance D (distance from the epicenter X, Y to a specific location X0, Y0) in the specific location and the magnitude M of the earthquake. The specific location mentioned here means the latitude and longitude of a location where the master unit 1 is present.

The earthquake information calculation portion 11a determines a standard intensity Sr in the specific location from the epicentral distance D, the magnitude M of the earthquake and the depth H of a hypocenter. Then, the amplification factor A of the specific location depending on its geological condition and the like is determined, and the standard intensity Sr and the amplification factor A are used to determine the predicted intensity of the primary shock (S waves), the maximum speed, the maximum acceleration, the maximum displacement, the predicted arrival time and the like. The calculation method used by the earthquake information calculation portion 11a is not limited to what is described above, and it can be appropriately modified according to the usage and the content of data included in the earthquake early warning.

Moreover, the earthquake information calculation portion 11a calculates, from the predicted arrival time and the current time given by a timer (not shown), the predicted period up to the arrival of the primary shock, that is, an allowance period during which the user can perform evacuation activities. The calculation results are fed to the following earthquake information transmission portion 11b and the backlight control portion 11c. The earthquake information calculation portion 11a performs the calculation processing described above each time the earthquake early warning is newly received.

When the earthquake information transmission portion 11b receives the calculation results from the earthquake information calculation portion 11a, it transmits, with the communication control portion 15, to the slave units 2, earthquake information including the calculated predicted primary shock arrival time, the predicted seismic intensity and the predicted period up to the arrival of the primary shock.

When the backlight control portion 11c receives the predicted period up to the arrival of the primary shock from the earthquake information calculation portion 11a, it provides an instruction to perform the turning on and off of the backlights of a group of operation buttons included in the input portion 14 to the light emission portion 20 on an individual operation button basis. In this way, the group of operation buttons displays the value of the predicted period by the same method as used in an electronic display panel.

The backlight control portion 11c updates the predicted period every predetermined period, for example, every second. Each time the predicted period is updated, an instruction to control the turning on and off of the backlights to display the updated predicted period is provided to the light emission portion 20. A specific example of the predicted period displayed by the input portion 14 and the light emission portion 20 will be described later.

The memory 12 is a medium that temporarily stores various types of data held by the master unit 1; the memory 12 is formed with, for example, a rewritable RAM (random access memory). The memory 12 serves as a buffer memory that temporarily stores: data to be processed when the control portion 11 performs various types of communication control processing; instruction commands received from the user; and the like. The memory 12 also serves to store the latitude/longitude information that is used for the calculation of the predicted primary shock arrival time.

The display portion 13 displays, to the user, various types of information (such as the telephone number of the sending side at the time of reception) held by the master unit 1. As the display portion 13, a small display device, such as a liquid crystal panel, that consumes a small amount of power is used.

The input portion 14 is used so that the user carries out various operations (such as the entering of the telephone number of a called party) to perform communication by the use of the master unit 1. The input portion 14 is generally formed with a plurality of operation buttons such as numeric buttons and a redial button. Behind the operation buttons, there are provided backlights that include light emission members such as LEDs included in the light emission portion 20, which will be described later.

The communication control portion 15 is a communication interface for connecting the master unit 1 to the wired LAN 41. The communication control portion 15 communicates with a call control server (not shown) connected to the wired LAN 41 and can thereby perform incoming processing, outgoing processing and the like on the IP telephone system. The communication control portion 15 controls wireless communication that is performed by the antenna device 16 through the wireless communication network 42.

The antenna device 16 is a wireless communication device for exchanging wireless communication radio with the slave units 2. The antenna device 16 performs wireless communication according to predetermined communication standards such as a communication method that complies with “FHSS-WDCT (frequency hopping spread spectrum—world digital cordless telephone).” In this way, it is possible to perform sound communication, data communication and the like with the slave units 2.

The sound signal processing portion 17 performs decoding processing on sound data input by the communication control portion 15, and feeds the resulting data as sound signals to the speaker 18. The sound signal processing portion 17 also performs predetermined coding processing on sound signals input from the microphone 19 to generate sound data, and feeds it to the communication control portion 15. Thus, the sound data is transmitted to a telephone device that is connected through the wired LAN 41, the wireless communication network 42, the IP telephone network 61 or the like.

The light emission portion 20 is an illumination device that includes the light emission members such as LEDs. The light emission portion 20 includes, for example, the backlights for the operation buttons included in the input portion 14 and members such as an incoming lamp that lights up at the time of reception. The light emission portion 20 receives an instruction from the backlight control portion 11c, and thus displays a number corresponding to the predicted period up to the arrival of the primary shock by lighting the backlights for the operation buttons. An example of the method of lighting the buttons according to the predicted period will be described later.

### <1-3. The Internal Configuration of the Slave Unit>

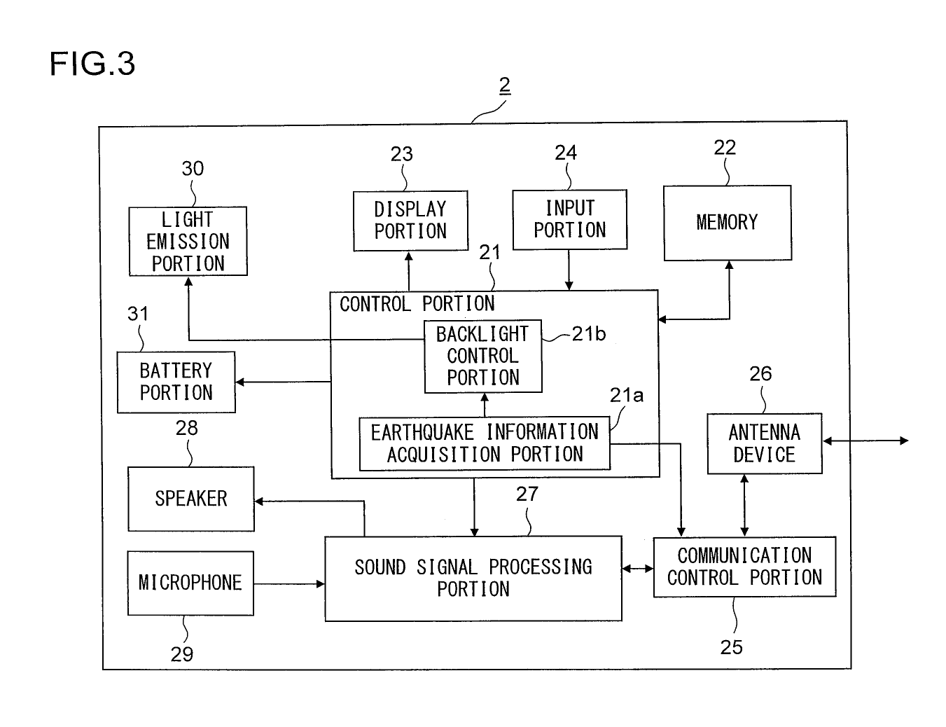

FIG. 3 is a block diagram showing the interior of the slave unit 2 according to the first embodiment of the invention. The slave unit 2 is configured to include at least a control portion 21, a memory 22 (=storage portion), a display portion 23, an input portion 24, a communication control portion 25 (=second communication portion), an antenna device 26 (=wireless communication portion), a sound signal processing portion 27, a speaker 28, a microphone 29, a light emission portion 30 and a battery portion 31.

The control portion 21 is a central processing unit for collectively controlling communication control processing (such as the exchange of sound data, making a call and the detection of whether a call is received) by controlling the individual portions of the slave unit 2. As function portions that are provided by executing programs on the central processing unit included in the control portion 21, the control portion 21 is provided with an earthquake information acquisition portion 21a and a backlight control portion 21b (=predicted period display portion).

The earthquake information acquisition portion 21a extracts the earthquake information from various types of information received from the master unit 1. The values included in the extracted earthquake information are fed to the backlight control portion 21b.

When the backlight control portion 21b receives the earthquake information from the earthquake information acquisition portion 21a, it feeds an instruction to perform control based on the value of the predicted period included in the earthquake information. When the light emission portion 30 receives the instruction, it controls the turning on and off of the backlights of a group of operation buttons included in the input portion 24 on an individual operation button basis. In this way, the group of operation buttons displays the value of the predicted period by the same method as used in an electronic display panel.

The backlight control portion 21b may have the function of updating the predicted period every predetermined period, for example, every second. In this case, each time the predicted period is updated, an instruction to perform control to display the updated predicted period is provided to the light emission portion 30.

The memory 22 is a medium that temporarily stores various types of data held by the slave unit 2; the memory 22 is formed with, for example, a rewritable RAM (random access memory). The memory 22 serves as a buffer memory that temporarily stores: data to be processed when the control portion 21 performs various types of communication control processing; instruction commands received from the user; and the like.

The display portion 23 displays, to the user, various types of information (such as the telephone number of the sending side at the time of reception) held by the slave unit 2. As the display portion 23, a small display device, such as a liquid crystal panel, that consumes a small amount of power is used.

The input portion 24 is used so that the user carries out various operations (such as the entering of the telephone number of a called party) to perform communication by the use of the slave unit 2. The input portion 24 is generally formed with a plurality of operation buttons such as numeric buttons and a redial button. Behind the operation buttons, there are provided backlights that include light emission members such as LEDs included in the light emission portion 30, which will be described later.

The communication control portion 25 controls wireless communication performed by the antenna device 26. Thus, it is possible for the slave unit 2 to communicate with the master unit 1 connected to the wireless communication network 42. It is also possible to perform incoming processing, outgoing processing and the like through the master unit 1 via the PSTN 63.

The components from the antenna device 26 to the light emission portion 30 have the same configuration as the components from the antenna device 16 to the light emission portion 20 in the master unit 1, and thus the description thereof will not be repeated.

The battery portion 31 receives electric power from an external power supply (not shown), and temporarily stores the electric power. For example, a rechargeable alkaline battery or a lithium ion battery is used as the battery portion 31.

### <1-4. The External Structure of the Slave Unit>

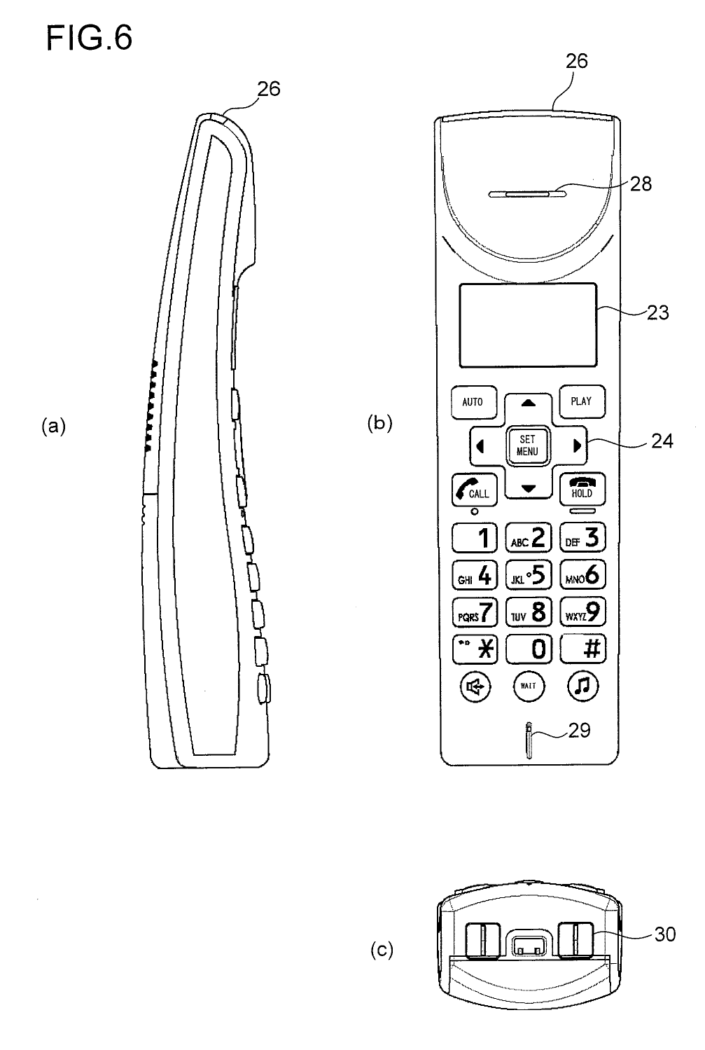

FIG. 6 is a diagram showing the external structure and appearance of the slave unit 2 according to the first embodiment of the invention. FIG. 6(a) is a diagram showing the appearance of the slave unit 2 as seen from the side thereof; FIG. 6(b) is a diagram showing the appearance of the slave unit 2 as seen from the front; and FIG. 6(c) is a diagram showing the appearance of the slave unit 2 as seen from the bottom.

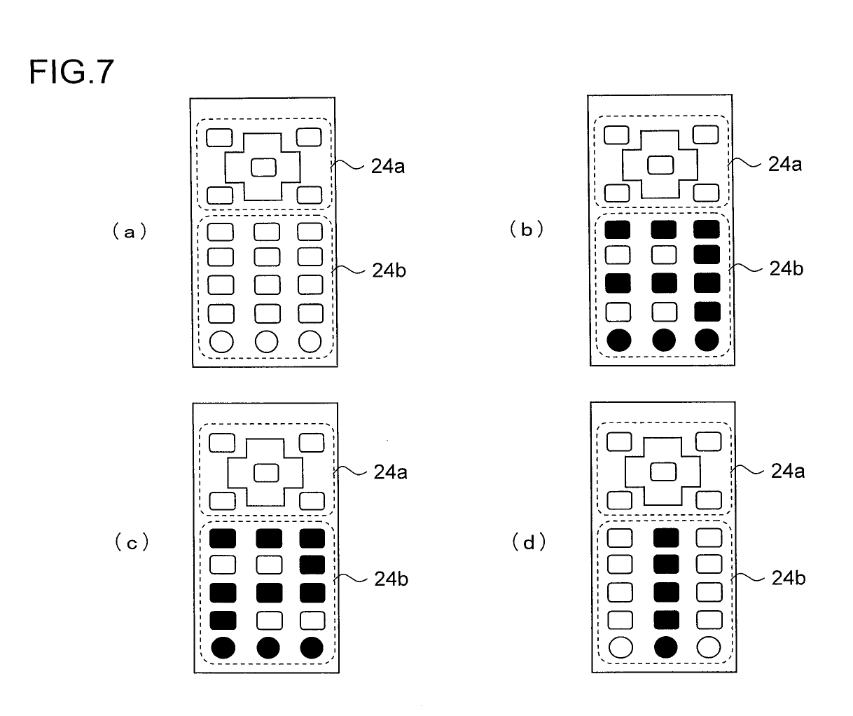

As shown in FIG. 6, the slave unit 2 has, on its front, the display portion 23, the input portion 24, the antenna device 26, the speaker 28 and the microphone 29. The slave unit 2 also has the rechargeable battery portion 31 in its bottom. Blow the display portion 23 including the liquid crystal panel, the input portion 24 having the group of operation buttons is provided. As shown in FIG. 7, the input portion 24 is divided into an arrow key 24a and a numeric keypad 24b.

FIG. 7 is a diagram schematically showing the configuration of the input portion 24. FIG. 7(a) shows the input portion 24 in a state where the backlights are not lit by the light emission portion 30. FIGS. 7(b) to 7(d) show the input portion 24 in a state where the backlights are lit to show the predicted period up to the arrival of the primary shock by the instruction from the backlight control portion 21b.

In FIG. 7(b), among the buttons included in the numeric keypad 24b, buttons filled in with black indicate buttons that are lit. The predetermined buttons are lit in this way, and a figure “3” is shown. This indicates that the predicted period up to the arrival of the primary shock is three seconds at this point.

In this state, the predicted period is updated by the backlight control portion 21b, and, as shown in FIG. 7(c), a figure “2” is shown as the predicted period. After the lapse of one second, the predicted period is also updated, and, as shown in FIG. 7(d), a figure “1” is shown as the predicted period.

As described above, the backlight control portion 21b controls the backlights such that the input portion 24 transfers from the state of FIG. 7(b) to the state of FIG. 7(d) every second. Thus, it is possible to perform the countdown display of the predicted period. The input portion 14 included in the master unit 1 has the same configuration as the input portion 24 shown in FIG. 7.

### <1-5. Predicted Period Notification Processing>

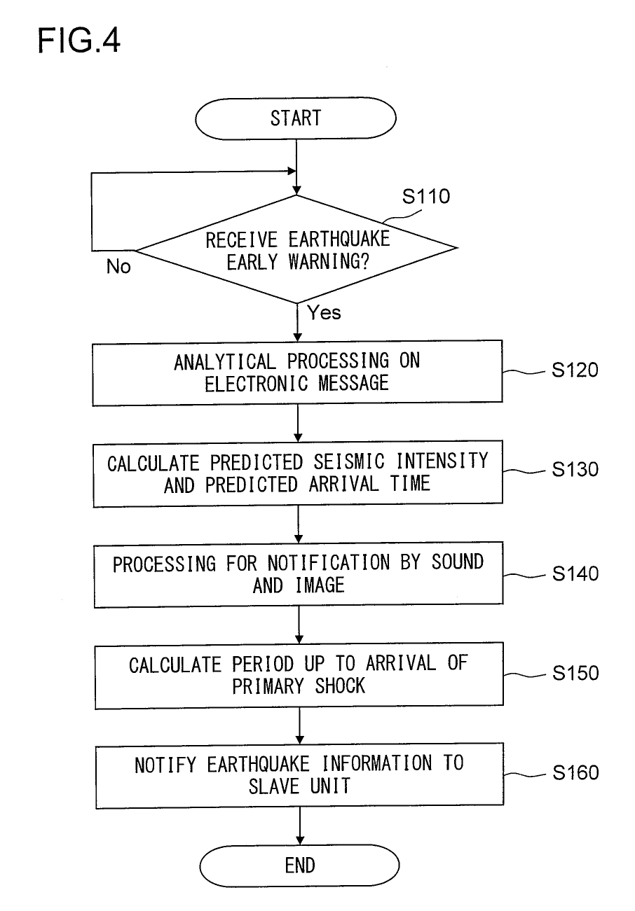

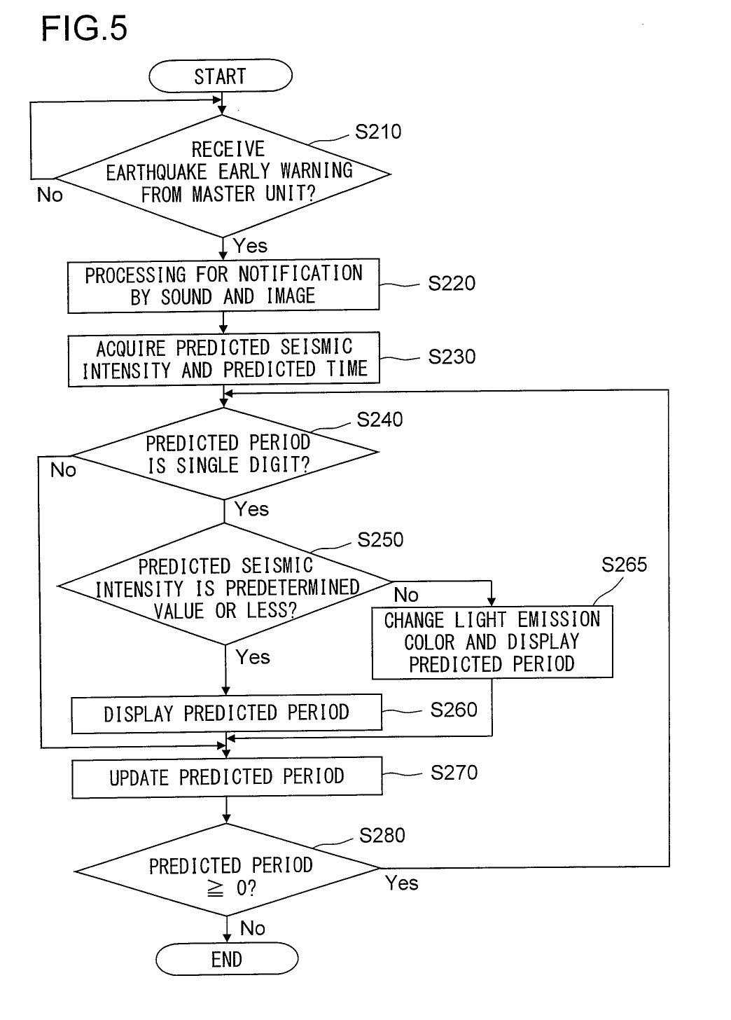

Predicted period notification processing that is performed with the master unit 1 and the slave units 2 of the first embodiment of the present invention when the earthquake early warning is received will now be described with reference to the block diagrams of FIGS. 1 to 3, the flowcharts of FIGS. 4 and 5 and the schematic diagram of FIG. 7.

FIG. 4 is a flowchart showing processing performed in the master unit 1 that is on standby for the reception of the earthquake early warning. The processing shown in the flowchart of FIG. 4 can be started with any timing in a state where the power supply of the master unit 1 is turned on and communication can be performed on the Internet 62. After the start of this processing, in step S110, the earthquake information calculation portion 11a determines whether or not the communication control portion 15 receives the earthquake early warning through the Internet 62.

If the earthquake information calculation portion 11a determines that the earthquake early warning is not received, the process returns to step S110 where the monitoring is continued until the detection of the earthquake early warning. If the reception of the earthquake early warning is detected, the earthquake information calculation portion 11a performs, in step S120, analytical processing on an electronic message included in the earthquake early warning. Thus, various parameters, included in the electronic message, such as a predicted seismic intensity calculation parameter and a predicted period calculation parameter are acquired.

Then, the earthquake information calculation portion 11a performs, in step S130, calculation processing with the acquired parameters and the latitude/longitude information stored in the memory 12. In this way, the predicted seismic intensity in an area where the master unit 1 is located and the predicted time when the primary shock reaches the area are calculated.

Then, in step S140, the earthquake information calculation portion 11a performs processing for providing a notification of the occurrence of an earthquake in the form of sound and an image. For example, a message indicating the occurrence of the earthquake and a character image indicating a seismic intensity such as “seismic intensity 5 upper” are displayed with the display portion 13. For example, a sound message and an alarm sound that indicate the occurrence of the earthquake are output with the speaker 18. Specifically, for example, a guidance sound, such as “beep, seismic intensity 5 upper, 15 seconds before, 14 seconds before, 13 seconds before, . . . ”, that includes countdown information is output.

Then, in step S150, the earthquake information calculation portion 11a calculates the predicted period up to the arrival of the primary shock. For example, the current time is acquired from a clock circuit (not shown), and a difference between the current time and the predicted time, calculated in step S130, when the primary shock reaches the area is calculated, with the result that the predicted period is calculated.

Then, in step S160, the earthquake information transmission portion 11b transmits, to one or a plurality of slave units 2 by the use of the communication control portion 15 and the antenna device 16, the earthquake information including the seismic intensity, the predicted time when the primary shock reaches the area and the predicted period up to the arrival of the primary shock that are calculated by the earthquake information calculation portion 11a. Then, the transmission is completed, and thus this processing is completed.

The processing performed in the slave unit 2 will now be described with the flowchart of FIG. 5. The processing shown in the flowchart of FIG. 5 can be started with any timing in a state where the slave unit 2 is on standby and wireless communication with the master unit 1 can be performed. After the start of this processing, in step S210, the earthquake information acquisition portion 21a determines whether or not the antenna device 26 receives, from the master unit 1, the earthquake information on the occurrence of the earthquake.

If the earthquake information acquisition portion 21a determines that the earthquake information is not received, the process returns to step S210 where the monitoring is continued until the detection of the earthquake information. If the reception of the earthquake information is detected, the earthquake information acquisition portion 21a performs, in step S220, processing for providing a notification of the occurrence of the earthquake in the form of sound and an image. Specifically, a character image indicating the predicted seismic intensity is displayed with the display portion 23, and a sound message and an alarm sound that indicate the predicted time when the primary shock reaches the area are output with the speaker 28.

Then, in step S230, the earthquake information acquisition portion 21a extracts the predicted seismic intensity and the predicted period up to the arrival of the primary shock from the earthquake information received from the master unit 1. The predicted seismic intensity and the predicted period that are extracted are fed to the backlight control portion 21b.

Then, in step S240, the backlight control portion 21b determines whether or not the value of the predicted period fed by the earthquake information acquisition portion 21a is a single digit, that is, any of the digits from 0 to 9. If the value is not a single digit, such as if the predicted period is determined to be 20 seconds, the process transfers to step 270, which will be described later.

If the predicted period is determined to be a single digit in step S240, the backlight control portion 21b determines, in step S250, whether or not the predicted seismic intensity fed from the earthquake information acquisition portion 21a is more than a predetermined value such as seismic intensity 5. If the predicted seismic intensity is not more than the predetermined value, in step S260, the light of the backlights is controlled with the light emission portion 30.

As a result, for example, if the predicted period is three seconds, as shown in FIG. 7(b), the numeric keypad 24b is lit to show a figure “3”. The information (=light emission member information) as to which backlights are lit or extinguished according to the value of the predicted period is incorporated in the program of the backlight control portion 21b or is stored in a storage medium such as the memory 22.

If, in step S250, the predicted seismic intensity is more than the predetermined value, in step S265, the light of the backlights is controlled with the light emission portion 30, using a color, different from the normal color used in step S260, of the backlights that are lit. For example, when the normal color of the lit backlights is white, the color is changed to red, which more attracts the attention of the user, and then the backlights are lit. The same processing as the light control processing in step S260 is performed except that the color of the light is different.

Then, in step S270, the backlight control portion 21b updates the predicted period after the lapse of a predetermined period such as one second. When the current time is past the predicted time when the primary shock reaches the area with the passage of time, the value of the predicted period becomes negative. Then, in step S280, whether or not the current predicted period is equal to or more than zero is determined. If the current predicted period is equal to or more than zero, the process returns to step S240. If the current predicted period is less than zero, that is, if it becomes negative, this processing is completed.

A second embodiment of the present invention will now be described with reference to the accompanying drawings.

### Embodiment 2

### <2-1. The Configuration of the Telephone System>

The configuration of the telephone system is the same as in Embodiment 1, and thus the description thereof will not be repeated.

### <2-2. The Internal Configuration of the Master Unit>

The components that constitute the master unit are the same as in Embodiment 1, but the function of the earthquake information transmission portion 11b differs partially from that of Embodiment 1. The earthquake information transmission portion 11b of this embodiment updates, with a timer (not shown), the predicted period up to the arrival of the primary shock that is fed from the earthquake information calculation portion 11a every predetermined period, for example, every second.

Each time the predicted period is updated, the earthquake information transmission portion 11b transmits, with the communication control portion 15, the updated predicted period to the slave unit 2. If a predicted period is newly calculated by the earthquake information calculation portion 11a, the processing for updating the predicted period is performed based on the new predicted period. In this case, data on the old predicted period is abandoned. A signal indicating that the new predicted period is calculated is transmitted to the slave unit 2, and thus a notification of the change of the predicted period may be provided to the user.

### <2-3. The Internal Configuration of the Slave Unit>

The components that constitute the slave unit are the same as in Embodiment 1, but the function of the backlight control portion 21b differs partially from that of Embodiment 1. Unlike Embodiment 1, the backlight control portion 21b of this embodiment does not update the predicted period every predetermined period. Hence, each time the predicted period is fed from the earthquake information acquisition portion 21a, an instruction to control the turning on and off of the backlights of the numeric keypad 24b is provided to the light emission portion 30. Thus, as compared with Embodiment 1, it is possible to simplify the processing performed in the slave unit 2.

### <2-4. The External Structure of the Slave Unit>

The external structure of the slave unit is the same as in Embodiment 1, and thus the description thereof will not be repeated.

### <2-5. Predicted Period Notification Processing>

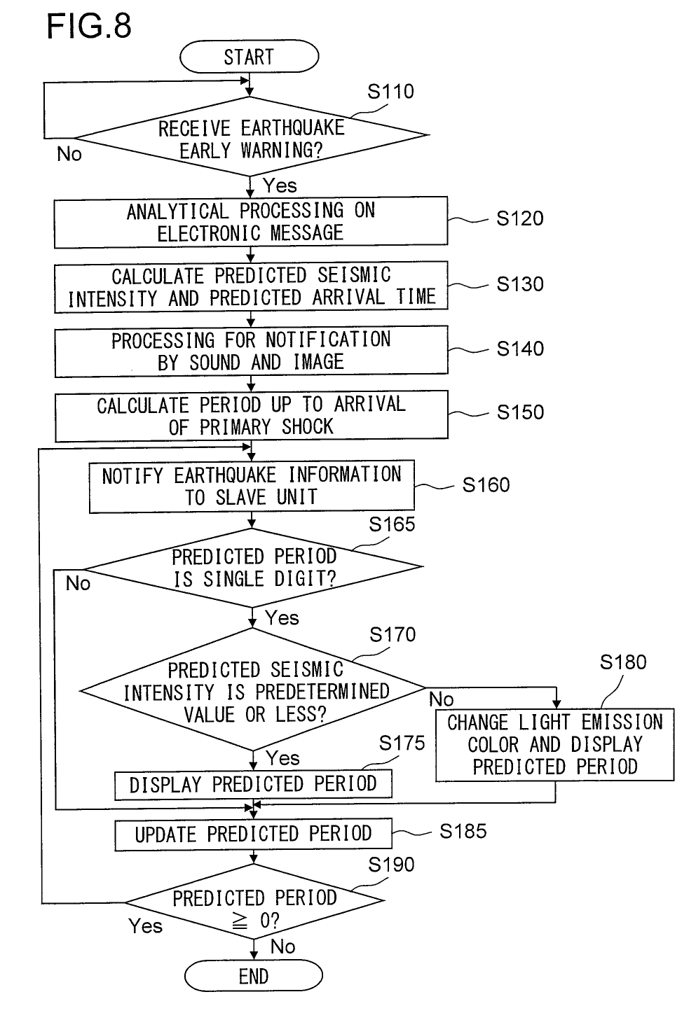

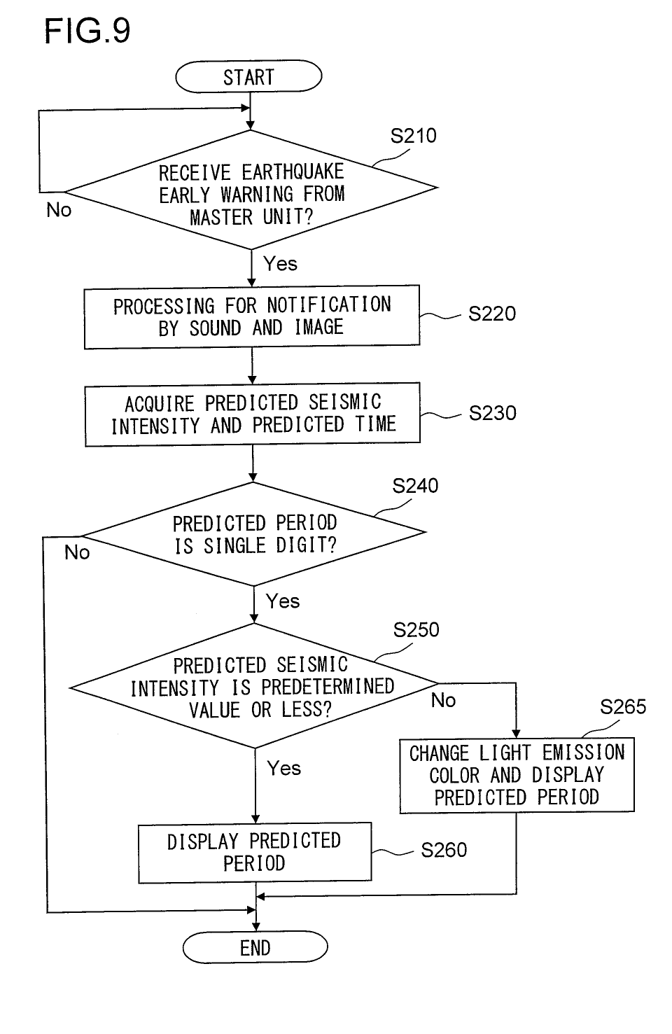

Predicted period notification processing that is performed with the master unit 1 and the slave units 2 of the first embodiment of the present invention when the earthquake early warning is received will now be described with reference to the block diagrams of FIGS. 1 to 3, the flowcharts of FIGS. 8 and 9 and the schematic diagram of FIG. 7. The same step numbers as in Embodiment 1 are added to the same types of processing as in Embodiment 1, and thus the description thereof will not be repeated.

FIG. 8 is a flowchart showing processing performed in the master unit 1 that is on standby for the reception of the earthquake early warning. The processing shown in the flowchart of FIG. 8 can be started with any timing in a state where the power supply of the master unit 1 is turned on and communication can be performed on the Internet 62. The processing in steps S110 to S160 is the same as in Embodiment, and thus the description thereof will not be repeated.

In step S160, the backlight control portion 11c transmits the earthquake information to the slave unit 2, and thereafter the backlight control portion 11c determines, in step S165, whether or not the value of the predicted period that is fed is a single digit, that is, any of the digits from 0 to 9. If the value is not a single digit, the process transfers to step 185, which will be described later.

If the predicted period is determined to be a single digit in step S165, the backlight control portion 11c determines, in step S170, whether or not the predicted seismic intensity that is fed is more than a predetermined value such as seismic intensity 5. If the predicted seismic intensity is not more than the predetermined value, in step S175, the light of the backlights is controlled with the light emission portion 20.

As a result, for example, if the predicted period is three seconds, as with the input portion 24 of the slave unit shown in FIG. 7(b), the numeric keypad 14b is lit to show a figure “3”. The information (=light emission member information) as to which backlights are lit or extinguished according to the value of the predicted period is incorporated in the program of the backlight control portion 11c or is stored in a storage medium such as the memory 22.

If, in step S170, the predicted seismic intensity is more than the predetermined value, in step S180, the light of the backlights is controlled with the light emission portion 20, using a color, different from the normal color used in step S175, of the backlights that are lit. For example, when the normal color of the lit backlights is white, the color is changed to red, which more attracts the attention of the user, and then the backlights are lit. The same processing as the light control processing in step S175 is performed except that the color of the lit backlights is different.

Then, in step S185, the backlight control portion 11c updates the predicted period after the lapse of a predetermined period. For example, each time one second elapses, the predicted period is updated such that it is decreased by one second. When the current time is past the predicted time when the primary shock reaches the area, the value of the predicted period becomes negative. Then, in step S190, whether or not the current predicted period is equal to or more than zero is determined. If the current predicted period is equal to or more than zero, the process returns to step S160. If the current predicted period is less than zero, that is, if it becomes negative, this processing is completed.

The processing performed in the slave unit 2 will now be described with the flowchart of FIG. 9. The processing shown in the flowchart of FIG. 9 can be started with any timing in a state where the slave unit 2 is on standby and wireless communication with the master unit 1 can be performed. As shown in FIG. 9, the processing of the flowchart in this embodiment is only composed of the processing in steps S210 to S260 among the processing of the flowchart in Embodiment 1 shown in FIG. 5.

Thus, if, in step S240, the backlight control portion 21b determines whether or not the value of the predicted period is a single digit, and then determines that the value is not a single digit, this processing is completed. If the value of the predicted period is a single digit, in step S260 or step S265, the light of the backlights is controlled with the light emission portion 30, and then this processing is completed.

### Embodiment 3

### <3-1. The Configuration of the Telephone System>

The configuration of the telephone system is the same as in Embodiment 1, and thus the description thereof will not be repeated.

### <3-2. The Internal Configuration of the Master Unit>

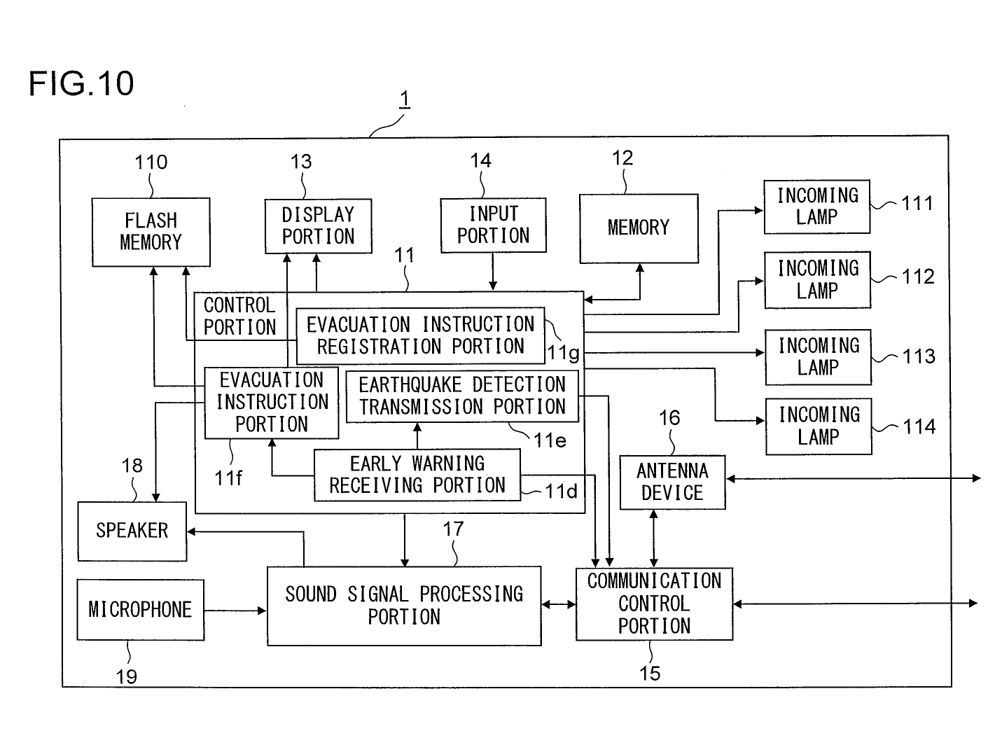

FIG. 10 is a block diagram showing the interior of the master unit 1 according to a third embodiment of the present invention. The master unit 1 of this embodiment includes not only the components of Embodiment 1 from the memory 12 to the microphone 19 but also a flash memory 110 and incoming lamps 111 to 114. Function portions included in the control portion 11 (=a setting portion and a prevention portion) are different.

As the function portions that are provided by executing programs on a central processing unit included in the control portion 11, the control portion 11 of this embodiment is provided with an early warning receiving portion 11d, an earthquake detection transmission portion 11e, an evacuation instruction portion 11f and an evacuation instruction registration portion 11g.

The early warning receiving portion 11d receives the earthquake early warning with the communication control portion 15 through the Internet 62, and thereby determines that the occurrence of the earthquake is detected. When the occurrence of the earthquake is detected, a notification of the detection of the earthquake is provided to the following earthquake detection transmission portion 11e and the evacuation instruction portion 11f.

When the earthquake detection transmission portion 11e receives the notification of the detection of the earthquake from the early warning receiving portion lid, it uses the communication control portion 15 to transmit the notification of the detection of the earthquake to the slave unit 2. When the evacuation instruction portion 11f receives the notification of the detection of the earthquake, it reads an evacuation instruction image and an evacuation instruction sound (hereinafter, referred to as “evacuation instruction data”) stored in the flash memory 110. Then, the read evacuation instruction data is output with the display portion 13 and the speaker 18, with the result that evacuation instructions are provided.

The evacuation instruction registration portion 11g receives an instruction to select, from image data and sound data stored in the flash memory 110, data that is used by the evacuation instruction portion 11f as the evacuation instruction data. The selection results are stored in the flash memory 110. The evacuation instruction portion 11f references the selection results to determine the evacuation instruction data to be output. The evacuation instruction registration portion 11g has the function of inputting, from the outside, image data and sound data to make the flash memory 110 store the data. For example, sound that is input from the microphone 19 is stored as the evacuation instruction sound.

The flash memory 110 is rewritable and is a nonvolatile semiconductor memory, in which data remains even if power is turned off. The flash memory 110 is one type of EEPROM, but differs from the EEPROM in that rewriting cannot be performed byte-by-byte and that deletion is previously performed block-by-block and then rewriting is performed. In this embodiment, the evacuation instruction data and the like used by the evacuation instruction portion 11f are stored in the flash memory 110, and a plurality of pieces of so-called telephone book data which can be stored such that telephone numbers correspond to the colors of light emitted by the incoming lamps 111 to 114 are also stored in the flash memory 110.

When the incoming lamps 111 to 114 (=light emission portions) receive the earthquake early warning, they emit red light or red blinking light. When a call is received, the incoming lamps 111 to 114 emit light of a color corresponding to the telephone number stored in the flash memory 110.

### <3-3. The Internal Configuration of the Slave Unit>

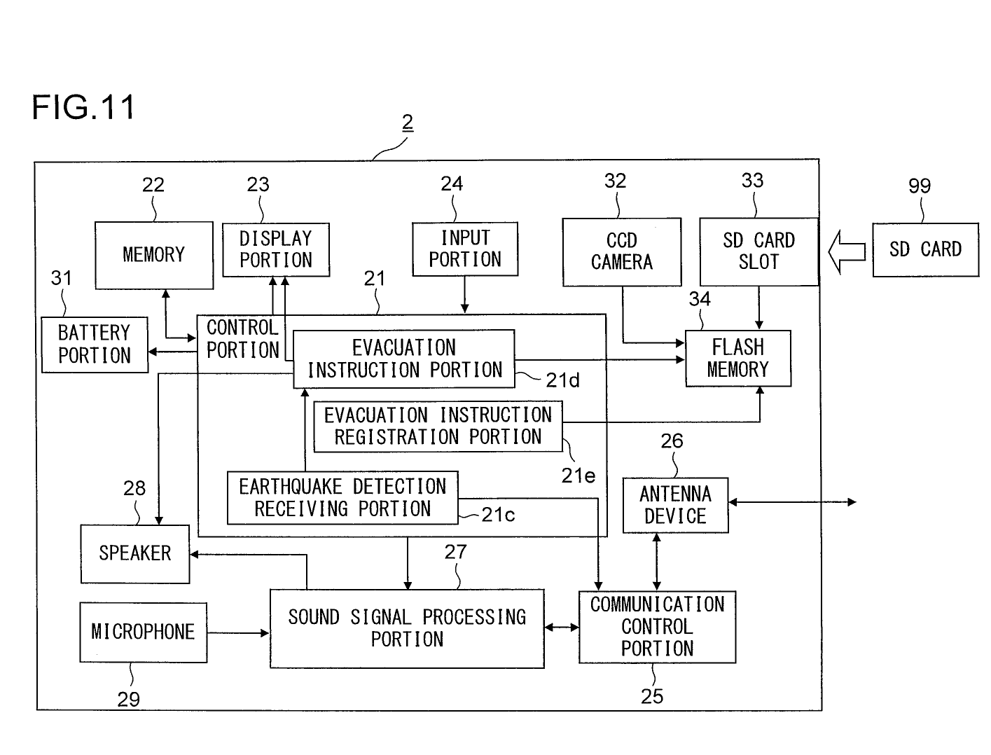

FIG. 11 is a block diagram showing the interior of the slave unit 2 according to the third embodiment of the present invention. The slave unit 2 of this embodiment includes not only the components from the memory 22 to the microphone 29 and the battery portion 31 of Embodiment 1 but also a CCD (charged coupled device) camera 32, a SD card slot 33 and a flash memory 34. A SD card 99 can be connected into the SD card slot 33.

As function portions that are provided by executing programs on a central processing unit included in the control portion 21, the control portion 21 of this embodiment is provided with an earthquake detection receiving portion 21c, an evacuation instruction portion 21d and an evacuation instruction registration portion 21e.

The earthquake detection receiving portion 21c determines whether or not the earthquake detection notification is included in various types of information received from the master unit 1. Then, if the earthquake detection receiving portion 21c determines that the earthquake detection notification is included therein, the earthquake detection receiving portion 21c feeds an electronic message indicating the detection of the earthquake to the evacuation instruction portion 21d.

When the evacuation instruction portion 21d receives, from the earthquake detection receiving portion 21c, the electronic message indicating the detection of the earthquake, the evacuation instruction portion 21d reads the evacuation instruction data stored in the flash memory 34. Then, the read evacuation instruction data is output with the display portion 23 and the speaker 28, with the result that the evacuation instructions are provided. Information such as the predicted seismic intensity and the predicted time when the primary shock reaches the area is also notified with the display portion 23 and the speaker 28.

The evacuation instruction registration portion 21e receives an instruction to select, from image data and sound data stored in the flash memory 34, data that is used by the evacuation instruction portion 21d as the evacuation instruction data. The selection results are stored in the flash memory 34. The evacuation instruction portion 21d references the selection results to determine the evacuation instruction data to be output. The evacuation instruction registration portion 21e has the function of receiving, from the outside, image data and sound data and storing the data in the flash memory 34.

The CCD camera is an image sensing portion that uses a CCD as an image sensing element. The CCD photoelectrically converts the optical image (optical information) of a subject that is formed by an image sensing lens (not shown) into image data of color components composed of R (red), G (green) and B (blue), and outputs it. The CCD is driven by a timing generator (not shown), and thus the aperture, the exposure time and the like are controlled. The image data obtained by the CCD camera is stored in the flash memory 34.

The SD card slot 33 is an interface into which the SD card 99 that is an external storage medium is connected and through which information is transmitted. For example, still images and moving image taken by a digital camera are stored in the SD card 99. The SD card slot 33 receives an instruction from the evacuation instruction registration portion 21e to copy and store the data in the flash memory 34. Thus, the evacuation instruction registration portion 21e can register the image and sound input from the outside as the evacuation instruction data.

<3-4. The Operations of the Device of this Embodiment>

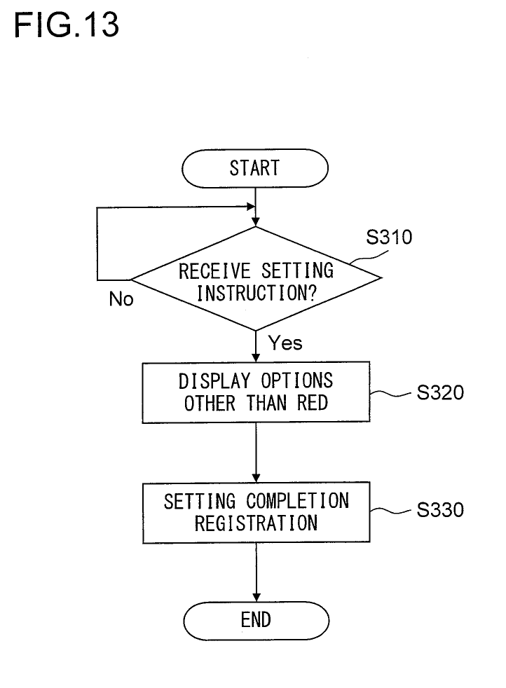

The operations of the master unit 1 and the slave unit 2 of the third embodiment of the present invention will now be described with reference to the block diagrams of FIGS. 10 to 12 and the flowchart of FIG. 13.

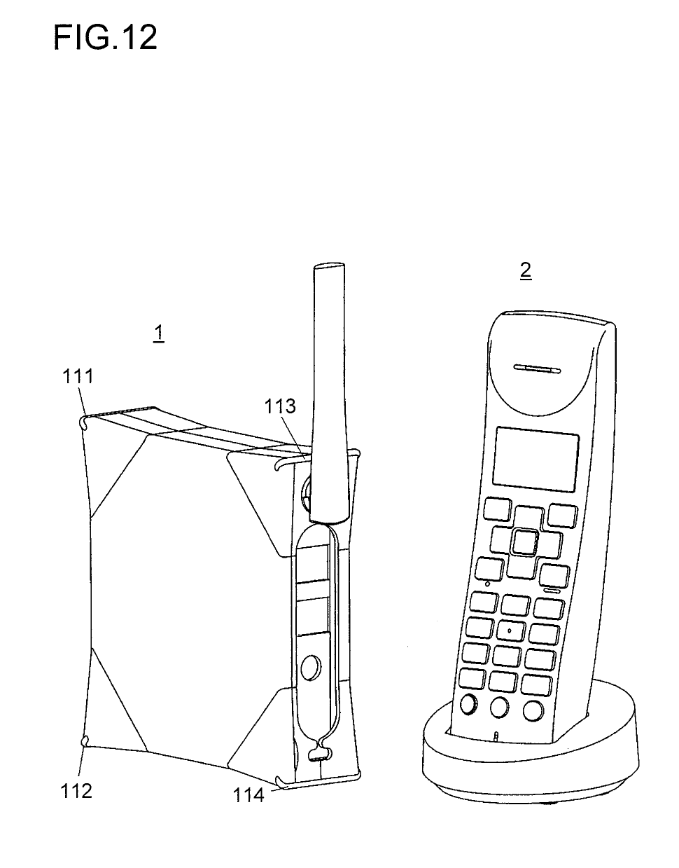

In the device of this embodiment, as shown in FIG. 12, the master unit 1 is shaped substantially in the form of a rectangular parallelepiped, and has the four incoming lamps (notification lamps) 111 to 114 in the four corners. When the earthquake early warning is received, these four incoming lamps 111 to 114 light up or blink.

FIG. 13 is a flowchart that shows the operation of the master unit 1 and that also shows an operation of setting the colors of light emitted by the incoming lamps 111 to 114.

In step S310 of FIG. 13, if the control portion 11 determines that an operation of starting to set the colors of light emitted by the incoming lamps 111 to 114 is performed at the input portion 14, the control portion 11 makes the process proceed to step S320.

In step S320, the control portion 11 displays, on the display portion 13, a list of colors (such as white, blue, green and yellow) excluding the color of light (for example, red) emitted when the earthquake early warning is received.

Then, in step S330, based on the operation of the input portion 14, the control portion 11 makes the color of the light correspond to the telephone number, and stores the associated information in the flash memory 110.

After such an operation, when the earthquake early warning is received, the incoming lamps 111 to 114 emit red light whereas, when normal reception (for example, the reception of a call) is performed, the incoming lamps 111 to 114 emit light of a color other than red.

### Embodiment 4

### <4-1. The Configuration of the Telephone System>

The configuration of the telephone system is the same as in Embodiment 1, and thus the description thereof will not be repeated.

### <4-2. The Internal Configuration of the Master Unit>

The internal configuration of the master unit is the same as in Embodiment 3, and thus the description thereof will not be repeated.

### <4-3. The Internal Configuration of the Slave Unit>

The internal configuration of the slave unit is the same as in Embodiment 3, and thus the description thereof will not be repeated.

<4-4. The Operations of the Device of this Embodiment>

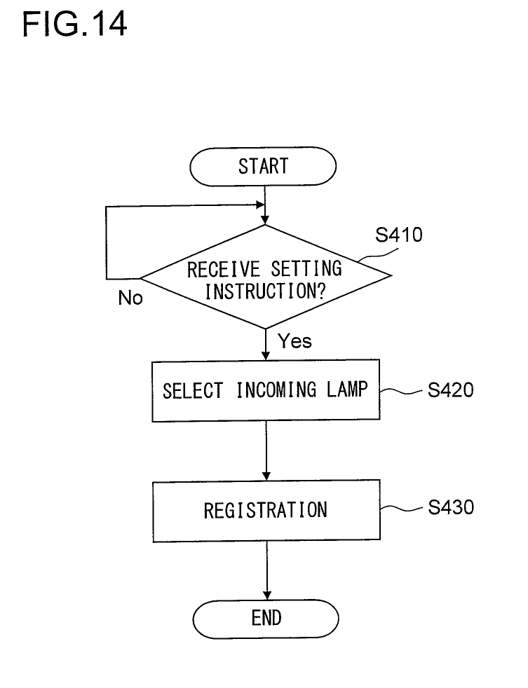

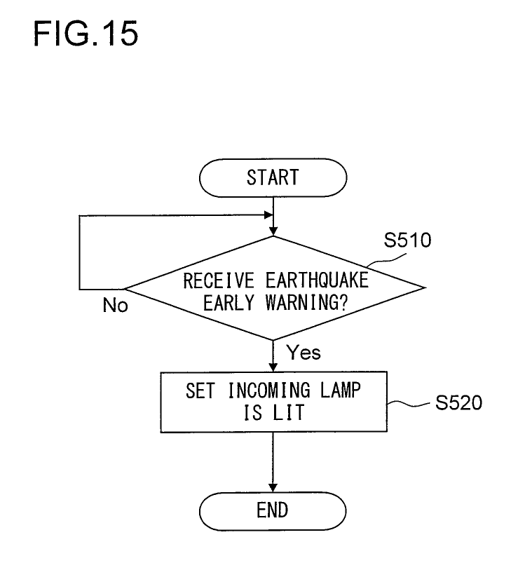

The operations of the master unit 1 and the slave unit 2 of a fourth embodiment of the present invention will now be described with reference to the block diagrams of FIGS. 10 to 12 and the flowcharts of FIGS. 14 and 15.

In the device of this embodiment, as shown in FIG. 12, the master unit 1 is shaped substantially in the form of a rectangular parallelepiped, and has the four incoming lamps (notification lamps) 111 to 114 in the four corners. When the earthquake early warning is received, these four incoming lamps 111 to 114 light up or blink. In this embodiment, it is possible for the user to set which ones of these four incoming lamps 111 to 114 are lit or blinked.

FIG. 14 is a flowchart that shows the operation of the master unit 1 and that also shows an operation for setting which incoming lamps are lit (blinked). In step S410 of FIG. 14, if the control portion 11 determines that an operation of providing an instruction to set the incoming lamps is performed at the input portion 14, the control portion 11 makes the process proceed to step S420.

In step S420, an operation of selecting incoming lamps that are lit (blinked) is performed at the input portion 14. For example, the incoming lamps 111 and 112 are assumed to be selected.

Then, in step S430, the control portion 11 stores information on the selected incoming lamps 111 and 112 in the memory 12. Specifically, the information indicating that, when the notification of the earthquake is provided, the incoming lamps 111 and 112 are only lit (blinked) is stored in the memory 12.

The operation performed when the earthquake early warning is received will now be described with reference to FIG. 15. In step S510 of FIG. 15, if the control portion 11 determines that the communication control portion 15 receives the earthquake early warning, the control portion 11 makes the process proceed to step S520.

In step S520, the early warning receiving portion 11d (=receiving portion) performs analytical processing on the electronic message included in the earthquake early warning. In this way, the predicted seismic intensity, the predicted time when the primary shock reaches the area and the like are calculated from various parameters included in the electronic message. The predicted seismic intensity, the predicted time when the primary shock reaches the area and the like are displayed on the display portion 13 and are output from the speaker 18 as a sound message. The control portion 11 also reads the information that is previously stored in the memory 12 and that indicates which incoming lamps are lit, and lights (or blinks), based on the read information, any (or all) of the four incoming lamps 111 to 114. For example, the incoming lamps 111 and 112 are only lit (or blinked).

### Embodiment 5

### <5-1. The Configuration of the Telephone System>

The configuration of the telephone system is the same as in Embodiment 1, and thus the description thereof will not be repeated.

### <5-2. The Internal Configuration of the Master Unit>

The internal configuration of the master unit is the same as in Embodiment 3, and thus the description thereof will not be repeated.

### <5-3. The Internal Configuration of the Slave Unit>

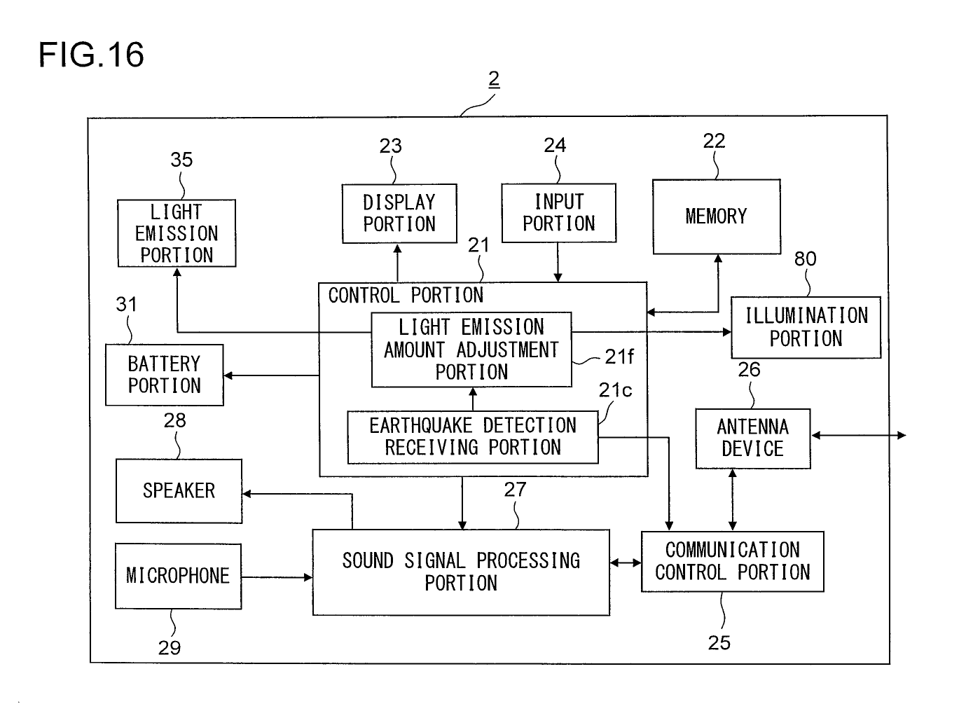

FIG. 16 is a block diagram showing the interior of the slave unit 2 according to a fifth embodiment of the present invention. The slave unit 2 of this embodiment includes not only the components from the memory 22 to the microphone 29 and the battery portion 31 of Embodiment 3 but also a light emission portion 35 and an illumination portion 80.

As function portions that are provided by executing programs on a central processing unit included in the control portion 21, the control portion 21 of this embodiment is provided with not only the earthquake detection receiving portion 21c of Embodiment 3 but also a light emission amount adjustment portion 21f.

When the light emission amount adjustment portion 21f receives, from the earthquake detection receiving portion 21c, the electronic message indicating the detection of the earthquake, the light emission amount adjustment portion 21f provides, to the light emission portion 35, an instruction to light a part or the whole of a light emission member (not shown) included in the light emission portion 35 at a predetermined amount of emitted light, for example, at the maximum amount of emitted light. The light emission amount adjustment portion 21f also provides an instruction to light up to the illumination portion 80. As the light emission members that are lit by the instruction, a button illumination unit (not shown) arranged behind the group of operation buttons included in the input portion 24, a liquid crystal panel backlight (not shown) included in the display portion 23 and the like are used.

After the light emission amount adjustment portion 21f receives the electronic message indicating the detection of the earthquake, the light emission amount adjustment portion 21f may prevent the light emission portion 35 and the illumination portion 80 from performing all the light emission control processing other than the lighting processing. For example, the blinking of the incoming lamps at the time of reception, the processing for adjusting the amount of light emitted by the liquid crystal panel backlight and the like are prevented. Thus, it is possible to preferentially perform only the lighting processing using the light emission member. The cancellation of the above prevention is performed such as by removing the battery of the slave unit 2 or inputting a predetermined command from the outside.

The light emission portion 35 is an illumination device that includes the light emission members such as LEDs. The light emission portion 35 controls the light emission of the light emission members such as the button illumination unit of the operation buttons included in the input portion 24, the incoming lamps that are lit at the time of reception and the backlights of the liquid crystal panel. The light emission portion 35 lights the light emission members at a predetermined amount of emitted light according to the instruction from the light emission amount adjustment portion 21f.

The illumination portion 80 is an illumination device that is arranged in an upper end of the surface of the slave unit 2. The illumination portion 80 does not light up at the time of a normal operation. Alternatively, the illumination portion 80 may be used as a reception notification lamp or the like. When the earthquake detection receiving portion 21c receives the notification of the detection of the earthquake early warning, the illumination portion 80 lights up at a predetermined amount of emitted light according to the instruction from the light emission amount adjustment portion 21f. The illumination portion 80 will be described in detail later.

### <5-4. The External Configuration of the Slave Unit>

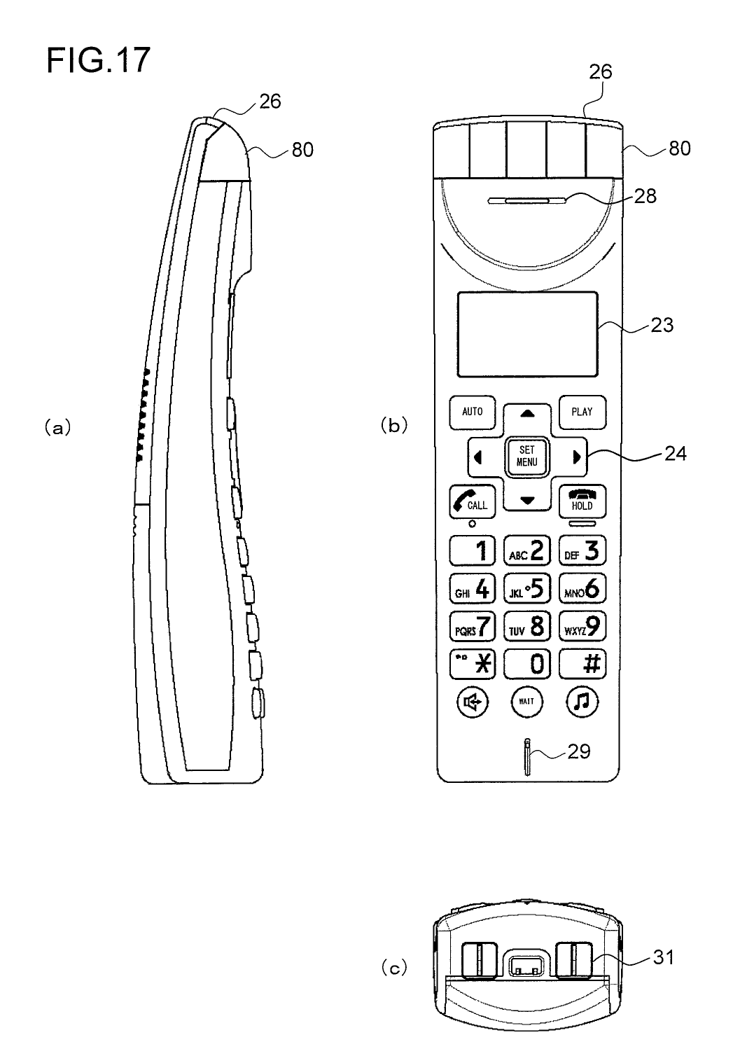

FIG. 17 is a diagram showing the appearance of the slave unit 2 according to the fifth embodiment of the present invention. FIG. 17(a) is a diagram showing the appearance of the slave unit 2 as seen from the side thereof; FIG. 17(b) is a diagram showing the appearance of the slave unit 2 as seen from the front; and FIG. 17(c) is a diagram showing the appearance of the slave unit 2 as seen from the bottom.

As shown in FIG. 17, the slave unit 2 has, on its front, the display portion 23, the input portion 24, the antenna device 26, the speaker 28, the microphone 29 and the illumination portion 80. The slave unit 2 also has the rechargeable battery portion 31 in its bottom. Behind the display portion 23 and the input portion 24, the light emission members (not shown) included in the light emission portion 35 are provided, and they can be lit as necessary.

### <5-5. The Configuration of the Illumination Portion>

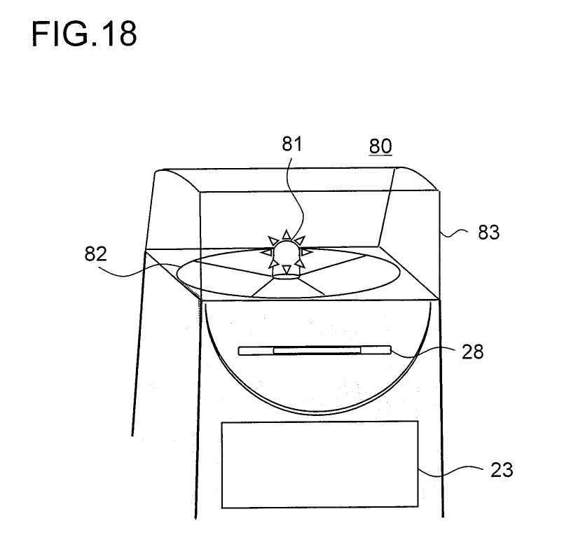

FIG. 18 is a perspective view showing an example of the internal structure of the illumination portion 80. The illumination portion 80 is configured to include at least a high-brightness LED 81, a reflective member 82, and a transparent member 83. The high-brightness LED 81 is a light emission member that is used in an LED light or the like. The detailed specifications of the high-brightness LED 81 and the color of light emitted by the high-brightness LED 81 are not particularly limited; since the high-brightness LED 81 is used for illumination, an LED that emits white light is preferably used.

The reflective member 82 is a member that is formed of aluminum foil, glass or the like, and that is used to reflect light beams. The reflective member 82 is used to reflect, among light beams emitted from the high-brightness LED 81, light beams emitted in the direction (in the downward direction in the example shown in FIG. 18) of the main body of the slave unit 2, toward the outside of the slave unit 2.

The transparent member 83 is a protection member that covers the high-brightness LED 81 and the reflective member 82 and that thereby prevents both the members from being exposed to the outside of the slave unit 2. The transparent member 83 is formed of a material such as a plastic having a certain amount of strength. The materials of which the reflective member 82 and the transparent member 83 are formed are not limited to those described above, and they can be changed as appropriate without departing from the scope of the present invention.

### <5-6. Processing for the Earthquake>

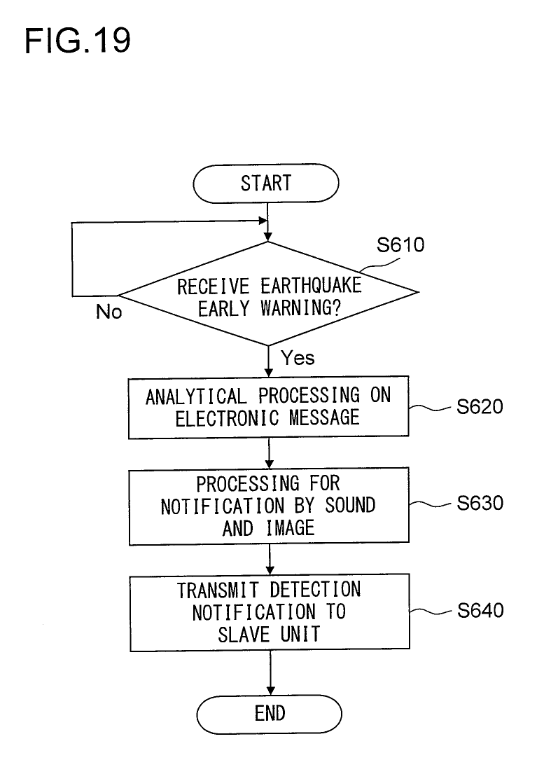

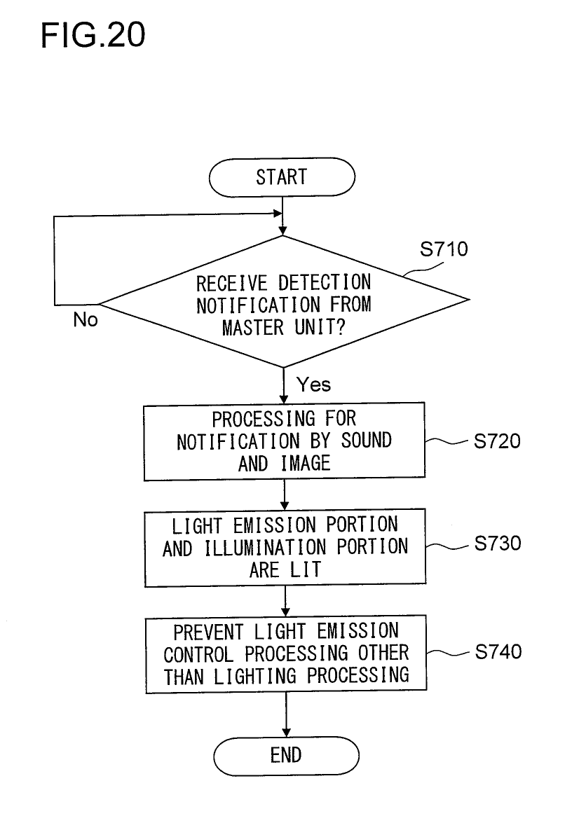

Processing for the earthquake that is performed in the master unit 1 and the slave unit 2 of the fifth embodiment of the present invention when the earthquake early warning is received will now be described with reference to the flowcharts of FIGS. 19 and 20.

FIG. 19 is the flowchart showing the processing performed in the master unit 1 that is on standby for the occurrence of the earthquake. The processing shown in the flowchart of FIG. 19 can be started with any timing in a state where the power supply of the master unit 1 is turned on and communication can be performed on the Internet 62. After the start of this processing, in step S610, the early warning receiving portion 11d determines whether or not the communication control portion 15 receives the earthquake early warning through the Internet 62 and the wired LAN 41.

If the early warning receiving portion 11d determines that the earthquake early warning is not received, the process returns to step S610 where repeated detection processing is performed until the detection of the earthquake early warning. If the reception of the earthquake early warning is detected, the early warning receiving portion 11d performs, in step S620, analytical processing on the electronic message included in the earthquake early warning. Thus, the predicted seismic intensity, the predicted time when the primary shock reaches the area and the like are calculated from various parameters included in the electronic message.

Then, in step S630, the control portion 11 reads the sound data and the image data for the evacuation instructions that are previously stored in the memory 12 and the like. Then, based on the read data, the sound and the image for the evacuation instructions are output with the display portion 13 and the speaker 18. The sound and the image used for the evacuation instructions are not particularly limited; for example, a sound and an image that indicate the predicted seismic intensity, the predicted time when the primary shock reaches the area and the like are output.

Then, in step S640, the earthquake information transmission portion 11b transmits, with the communication control portion 15 and the antenna device 16, the notification of the detection of the earthquake early warning to one or a plurality of slave units 2.

The processing performed in the slave unit 2 will now be described with reference to the flowchart of FIG. 20. The processing shown in the flowchart of FIG. 20 can be started with any timing in a state where the slave unit 2 is on standby and wireless communication with the master unit 1 can be performed. After the start of this processing, in step S710, the earthquake detection receiving portion 21c determines whether or not the antenna device 26 receives, from the master unit 1, the notification of the detection of the earthquake early warning.

If the earthquake detection receiving portion 21c determines that the notification of the detection is not received, the process returns to step S710 where the monitoring is continued until the reception of the notification of the detection. If the notification of the detection is received, the earthquake detection receiving portion 21c feeds an electronic message indicating the reception of the notification of the detection to the light emission amount adjustment portion 21f.

Then, in step S720, the control portion 11 reads the sound data and the image data for the evacuation instructions that are previously stored in the memory 22 and the like. Then, based on the read data, the sound and the image for the evacuation instructions are output with the display portion 23 and the speaker 28.

Then, in step S730, the light emission amount adjustment portion 21f provides, to the light emission portion 35, an instruction to light a part or the whole of the light emission member included in the light emission portion 35 at a predetermined amount of emitted light. The light emission amount adjustment portion 21f also provides an instruction to light the high-brightness LED 81 to the illumination portion 80. Then, in step S740, the light emission amount adjustment portion 21f provides, to the light emission portion 35 and the illumination portion 80, an instruction to prevent all the light emission control processing other than the lighting processing. In this way, both the members perform only the lighting processing, and thus it is possible to prevent the light from being extinguished by an erroneous operation of the user.

### Other Embodiments

Although the present invention is described above using the preferred embodiments and the examples, the invention is not necessarily limited to the above embodiments. Many variations are possible without departing from the scope of technical considerations of the invention.

Thus, the present invention is applicable to configurations described below.

(A) Although, in the embodiments described above, as the communication line through which the master unit 1 receives the earthquake early warning, the wired LAN 41 and the Internet 62 are used, the earthquake early warning may be received through communication networks, other than those mentioned above, such as a dedicated line and a cable television line. The earthquake early warning may be obtained from airwaves such as terrestrial digital broadcasting and BS digital broadcasting.

(B) Although the embodiments described above deal with the case where the function portions related to the predicted period notification processing are provided in the master unit 1 and the slave units 2, part of these function portions may be formed with an external device connected thereto through networks such as a telephone network and a LAN. For example, the latitude/longitude information that the earthquake information calculation portion 11a uses to calculate the predicted period may be stored in an information processing device (such as a network server) arranged on the network. Thus, for example, when the locations of the communication devices are changed, latitude/longitude information for a plurality of communication devices can be changed collectively.

(C) Although the embodiments described above deal with the case where the cordless telephone incorporating the master unit 1 and the slave units 2 is taken as an example of the communication device having the earthquake early warning notification function of the present invention, any other device may be used to practice the present invention as long as the device is a communication device that can receive the earthquake early warning by connecting to a wide area communication network. The present invention may be practiced with, for example, a wireless facsimile device, a wireless LAN connected mobile telephone, an internet telephone incorporating a slave unit, an IP telephone device incorporating a slave unit capable of IP communication, an information processing device such as a PDA or a notebook PC having a communication function.

(D) Although, in the embodiments described above, the function portions of the master unit 1 and the slave units 2 related to the predicted period notification processing of the present invention are provided by executing programs on the central processing unit such as a microprocessor, the function portions may be formed with a plurality of circuits.

(E) Although the embodiments described above deal with the case where the slave unit 2 having the wireless communication function is taken an example of the slave unit 2 related to the predicted period notification processing of the present invention, the predicted period notification processing of the present invention may be performed by a slave unit that does not have the wireless communication function but that can achieve only wire communication.

(F) Although, in the embodiments described above, when the predicted seismic intensity is more than seismic intensity 5, the color of emitted light is changed, the seismic intensity is previously divided into a plurality of categories, and the color of emitted light may be changed according to the categories. For example, when the predicted seismic intensity falls in the range between seismic intensity 1 and seismic intensity 3, the color of emitted light is changed to green; when the predicted seismic intensity falls in the range between seismic intensity 4 and seismic intensity 5, the color of emitted light is changed to orange; and when the predicted seismic intensity falls in the range of seismic intensity 6 and more, the color of emitted light is changed to red. Thus, it is possible to more minutely indicate the predicted seismic intensity.

(G) Although the embodiments described above deal with the case where the microphone 29, the CCD camera and SD card slot 33 are taken as examples of means for acquiring the evacuation instruction data from the outside, the evacuation instruction data may be acquired from means, other than those mentioned above, such as a USB connection terminal, an infrared input terminal, an external device connected to a communication network and the Internet.

(H) Although, in the embodiments described above, the present invention is practiced with the communication device that can receive the earthquake early warning, the present invention can be practiced with a communication device that can receive disaster information such as for a typhoon or a tsunami.

(I) Although the embodiments described above deal with the case where the button illumination unit and the backlight are taken as examples of the light emission member that is lit by the light emission amount adjustment portion 21f when the earthquake early warning is detected, a light emission member other than those mentioned above may be used. For example, when the slave unit 2 is provided with a CCD camera, the flash device of the CCD camera may be constantly lit such that it is used for illumination.

(J) Although, in the embodiments described above, all the light emission members included in the light emission portion 35 and the illumination portion 80 are lit when the earthquake early warning is detected, which light emission members are lit or unlit may be previously specified and set by the user. An illumination sensor is provided, and thus even when the earthquake early warning is received, unless the illumination around the slave unit 2 is equal to or less than a predetermined level, control may be performed such that the lighting is not performed. Thus, it is possible to utilize the power of the battery portion 31 effectively.

1. A communication device that includes:
a first communication portion connectable to a communication network;
an earthquake information calculation portion that receives, with the first communication portion, earthquake early warning through the communication network and that calculates a predicted period up to an arrival of a primary shock and a predicted seismic intensity;
an input portion including a group of operation buttons; and
a light emission portion including light emission members arranged behind the group of operation buttons, the communication device further comprising:
a predicted period display portion that controls the light emission portion such that the light emission members are lit/extinguished according to a value of the predicted period.

2. The communication device of claim 1, further comprising:
a storage portion that stores light emission member information indicating which light emission members need to be lit/extinguished to display any of digits from 0 to 9 with the light emission portion,
wherein the predicted period display portion determines, with the light emission member information, which light emission members are lit/extinguished according to the predicted period, and controls the light emission portion.

3. The communication device of claim 2, further comprising:
a main communication device including:
the first communication portion;
the earthquake information calculation portion;
the input portion;
the light emission portion;
the predicted period display portion; and
an earthquake information transmission portion that transmits, with the first communication portion, earthquake information including the predicted period up to the arrival of the primary shock and the predicted seismic intensity calculated by the earthquake information calculation portion; and
a sub-communication device including:
a second communication portion that can communicate with the main communication device;
an earthquake information acquisition portion that acquires the earthquake information from information received with the second communication portion;
the input portion;
the light emission portion; and
the predicted period display portion.

4. The communication device of claim 3,
wherein the first communication portion includes a wireless communication portion connectable to a wireless communication network;
the earthquake information transmission portion transmits, with the wireless communication portion included in the first communication portion, the earthquake information to the sub-communication device;
the second communication portion includes a wireless communication portion connectable to the wireless communication network; and
the earthquake information acquisition portion acquires the earthquake information from information received with the wireless communication portion included in the second communication portion.

5. The communication device of claim 4,
wherein the predicted period display portion updates the predicted period as time passes, and controls the light emission portion such that, each time the predicted period is updated, a figure indicating an updated predicted period is displayed with the light emission members.

6. The communication device of claim 4,
wherein the earthquake information transmission portion updates the predicted period as time passes, and transmits, with the first communication portion, an updated predicted period to the sub-communication device each time the predicted period is updated.

7. The communication device of claim 4,
wherein the predicted period display portion controls the light emission portion such that colors of the lit light emission members are changed according to a value of the predicted seismic intensity included in the earthquake information.

8. A communication device comprising:
a reception detection portion that detects reception;
a light emission portion that emits light according to the detection of the reception by the reception detection portion;
a setting portion that sets a color of light emitted by the light emission portion; and
a prevention portion that prevents, when the setting portion sets the color of light emitted, a predetermined color from being registered as the color of light emitted by the light emission portion.

9. The communication device of claim 8,
wherein, when the setting portion sets the color of light emitted, the prevention portion prevents red from being registered as the color of light emitted by the light emission portion.

10. The communication device of claim 1, further comprising:
a receiving portion that receives the earthquake early warning; and
light emission portions that light up or blink based on the reception by the receiving portion,
wherein two or more light emission portions are included, and the light emission portions that are lit or blinked when the receiving portion receives the earthquake early warning are selectable.

11. The communication device of claim 1,
wherein the communication device is shaped substantially in a form of a rectangular parallelepiped, the light emission portions that light up or blink are arranged in four corners of the rectangular parallelepiped and, among the light emission portions, light emission portions that are lit or blinked are selectable.

12. The communication device of claim 1,
wherein the communication device is shaped substantially in a form of a rectangular parallelepiped, and includes a receiving portion that receives the earthquake early warning and light emission portions that light up or blink based on the reception by the receiving portion, the light emission portions that light up or blink are arranged in four corners of the rectangular parallelepiped and, among the light emission portions, light emission portions that are lit or blinked are selectable.

13. The communication device of claim 8, further comprising:
a receiving portion that receives the earthquake early warning; and
light emission portions that light up or blink based on the reception by the receiving portion,
wherein two or more light emission portions are included, and the light emission portions that are lit or blinked when the receiving portion receives the earthquake early warning are selectable.

14. The communication device of claim 8,
wherein the communication device is shaped substantially in a form of a rectangular parallelepiped, the light emission portions that light up or blink are arranged in four corners of the rectangular parallelepiped and, among the light emission portions, light emission portions that are lit or blinked are selectable.

15. The communication device of claim 8,
wherein the communication device is shaped substantially in a form of a rectangular parallelepiped, and includes a receiving portion that receives the earthquake early warning and light emission portions that light up or blink based on the reception by the receiving portion, the light emission portions that light up or blink are arranged in four corners of the rectangular parallelepiped and, among the light emission portions, light emission portions that are lit or blinked are selectable.
